(19) United States
(12) Patent Application Publication
(10) Pub. No.: US 2014/0000346 A1
(43) Pub. Date: Jan. 2, 2014

(54) HIGH PRESSOR SENSORS FOR DETECTING MEMBRANE FOULING

(71) Applicants: Eric M.V. Hoek, Pacific Palisades, CA (US); Dian Tanuwidjaja, Placentia, GA (US)

(72) Inventors: Eric M.V. Hoek, Pacific Palisades, CA (US); Dian Tanuwidjaja, Placentia, GA (US)

(21) Appl. No.: 13/703,400

(22) PCT Filed: Jun. 21, 2011
(86) PCT No.: PCT/US11/41310

§ 371 Date: Jun. 17, 2013

Related U.S. Application Data
(60) Provisional application No. 61/356,827, filed on Jun. 21, 2010.

(51) Int. Cl. G01N 15/08

(52) U.S. Cl. CPC G01N 15/0826
USPC 73/38

(57) ABSTRACT

In one aspect, the invention relates to methods and devices for detecting membrane fouling in a membrane-based water processing system. This abstract is intended as a scanning tool for purposes of searching in the particular art and is not intended to be limiting of the present invention.

### CROSS-REFERENCE TO RELATED APPLICATIONS

This application claims the benefit of U.S. Application No. 61/356,827, filed Jun. 21, 2010, which is hereby incorporated herein by reference in its entirety.

### BACKGROUND

In recent years, reverse osmosis (RO) seawater desalination technology has undergone an important transformation. Current technology has increased membrane permeability and the high efficiency of pumping and energy recovery in seawater RO which saves energy to reduce desalinating cost. Further cost reductions to seawater desalination must involve simultaneously increasing product water recovery, decreasing operating pressure, and decreasing RO membrane fouling. Generally, seawater filtration membrane fouling is defined by an undesirable change in separation performance due to scale, cake, or biofilm formation (or some combination thereof). This undesirable change in performance generally manifests as an apparent decrease in membrane hydraulic resistance, hydraulic losses through the element, and salt passage through membranes. Thus, the consequences of membrane fouling are higher plant operating expenses, increased process downtime, and accelerated membrane degradation.

A recent trend in membrane research involves the use of ex situ, side-stream fouling detectors applied as early warning sensors at full-scale and pilot desalination plants. For example, Cohen et al. extended a laboratory-scale optical membrane module into a novel, ex situ scaling observation detector (EXSOD). Subsequently, they used the EXSOD system to optimize a brackish water RO pilot plant where mineral scaling was the primary performance limiting factor. Vrouwenvelder et al. developed an ex situ fouling detector they call a “membrane fouling simulator” (MFS) to monitor biological fouling in RO and NF filtration of surface and ground water. The MFS showed the same hydraulic behavior as spiral wound membrane modules, provided reproducible data, and was an effective early warning sensor of biological fouling by monitoring increased tangential pressure drop through the system; however, this MFS type of detector is not capable of pressure driven permeate production, such as required in seawater desalination.

Therefore, there remains a need for high pressure fouling detectors that can act as an early warning system to detect membrane fouling prior to the full scale seawater desalination system. Additionally, there remains a need for high pressure fouling detectors that can predict the performance of a full scale seawater desalination system.

### SUMMARY

In accordance with the purpose(s) of the invention, as embodied and broadly described herein, the invention relates to methods and devices for detecting membrane fouling in a membrane-based water processing system.

More specifically, described herein are methods for detecting membrane fouling in a membrane-based water processing system, the method comprising: providing a high pressure monitoring cell in parallel with the water processing system, the cell comprising a membrane; passing a sample side-stream from a feed stream or a brine stream of the water processing system through the membrane cell at an ambient feed or brine stream pressure, thereby generating a differential pressure along the membrane length, generating a transmembrane pressure drop through the membrane, and generating a membrane flux through the membrane; and measuring one or more of: differential pressure, wherein an increase indicates fouling of the water processing system membrane, transmembrane pressure drop, wherein an increase indicates fouling of the water processing system membrane, and flux, wherein a decrease indicates fouling of the water processing system membrane.

Also described herein are methods for detecting membrane fouling in a membrane-based desalination system, the method comprising: providing a high pressure monitoring cell in parallel with the desalination system, the cell comprising a membrane; passing a sample side-stream from a feed stream of the desalination system through the membrane cell at an ambient feed stream pressure, thereby generating a differential pressure along the membrane length, generating a transmembrane pressure drop through the membrane, and generating a permeate flux through the membrane; and measuring one or more of: differential pressure, wherein an increase indicates fouling of the desalination membrane, transmembrane pressure drop, wherein an increase indicates fouling of the desalination membrane, and permeate flux, wherein a decrease indicates fouling of the desalination membrane.

Also described herein are methods for detecting membrane fouling in a membrane-based salinity-gradient power system, the method comprising: providing a high pressure monitoring cell in parallel with the salinity-gradient power system, the cell comprising a membrane; passing a sample side-stream from a brine stream of the salinity-gradient power system through the membrane cell at an ambient brine stream pressure, thereby generating a differential pressure along the membrane length, generating a transmembrane pressure drop through the membrane, and generating a draw flux through the membrane; and measuring one or more of: differential pressure, wherein an increase indicates fouling of the salinity-gradient power system membrane, transmembrane pressure drop, wherein an increase indicates fouling of the salinity-gradient power system membrane, and draw flux, wherein a decrease indicates fouling of the salinity-gradient power system membrane.

Also described herein are high pressure monitoring cells for use in detecting membrane fouling in a membrane-based water processing system, the cell comprising: a membrane having a surface on an active feed side; and a flow head configured and arranged to direct a sample feed stream from the water processing system through the surface of the membrane and to thereby generate a concentrate stream on the active side of the membrane and a permeate stream opposite the active feed side of the membrane; and coupled to the cell, a means for measuring one or more of differential pressure, transmembrane pressure drop, and flux.

While aspects of the present invention can be described and claimed in a particular statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

### BRIEF DESCRIPTION OF THE FIGURES

The accompanying figures, which are incorporated in and constitute a part of this specification, illustrate several aspects and together with the description serve to explain the principles of the invention.

FIG. 1 shows high-pressure fouling detector (a) feed side and (b) permeate side blocks;

FIG. 2 shows low-pressure fouling detector (a) feed side and (b) permeate side blocks;

FIG. 3 shows a schematic diagram of fouling detector locations in the prototype desalination plant;

FIG. 4 shows schematic illustrations of a low-pressure fouling detector and a membrane fouling simulator experimental system;

FIG. 5 shows a schematic of a high-pressure fouling detector experimental system;

FIG. 6 shows feed spacer geometry;

FIG. 7 shows simulated velocity fields for (a) short segment of fouling detector spacer-filled feed channel and normalized solute concentration (b) at the membrane surface, (c) lateral velocity field through the channel, and (d) vertical velocity field at 10 μm above membrane surface;

FIG. 8 shows permeate flux data versus time for cartridge filtered, chlorinated, microfiltered, and dechlorinated seawater;

FIG. 9 shows permeate conductivity data versus time for cartridge filtered, chlorinated, microfiltered, and dechlorinated seawater;

FIG. 10 shows differential pressure data versus time for cartridge filtered, chlorinated, microfiltered, and dechlorinated seawater;

FIG. 11 shows normalized differential pressure data versus time for cartridge filtered, chlorinated, microfiltered, and dechlorinated seawater;

FIG. 12 shows a schematic of fouling detectors' feed water sources in the seawater filtration prototype system;

FIG. 13 shows membrane configurations for seawater filtration prototype system;

FIG. 14 shows performance vs. time data for different pretreatments for (a) permeate flux, (b) permeate conductivity, and (c) differential pressure;

FIG. 15 shows seawater filtration membranes before and after use for (a) clean new membrane at day 1, (b) LPFD MF+CF+ClO₂ at day 60, (c) LPFD MF+CF+UV at day 60, and (d) LPFD MF+GAC at day 60;

FIG. 16 shows a solids analysis for different types of pretreatments;

FIG. 17 shows ICP analysis for different types of pretreatments;

FIG. 18 shows live and dead staining images for membranes exposed to (a) LPFD MF+CF+ClO₂ and (b) LPFD MF+CF+UV;

FIG. 19 shows a bench scale set up schematic of an LPFD with nutrient addition;

FIG. 20 shows a bench scale set up schematic of a HPFD with nutrient addition;

FIG. 21 shows optical density analysis to represent the biogrowth in complex nutrient (N1), defined nutrient (N2), and seawater without added nutrients;

FIG. 22 shows differential pressure vs. time elapsed with complex nutrient (N1) and defined nutrient (N2) addition for LPFD, HPFD, and south train;

FIG. 23 shows salt rejection vs. time elapsed for HPFD with nutrient 1 and 2 addition compared to full scale (south train);

FIG. 24 shows normalized Permeate Flux vs. time for HPFD, HPFD with nutrient, South Train, and South Train with simulated nutrient;

FIG. 25 shows solids analysis for nutrient 1 and nutrient 2 addition;

FIG. 26 shows ICP analysis for (a) nutrient 1 addition and (b) nutrient 2 addition;

FIG. 27 shows scanning electron microscopy (SEM) analysis for (a) HPFD MF+CF+N1, (b) LPFD MF+CF+N1, and (c) LPFD MF+CF+N2;

FIG. 28 shows live and dead staining for membrane from (a) HPFD MF+CF+N1, (b) LPFD MF+CF+N1, and (c) LPFD MF+CF+N2;

FIG. 29 illustrates the pressure-retarded osmosis process;

FIG. 30 shows calculated PRO power density for membrane properties as reported and with an optimized permeability; and

FIG. 31 is a schematic illustrating operation of high pressure monitoring cells described herein.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DESCRIPTION

The present invention can be understood more readily by reference to the following detailed description of the invention and the Examples included therein.

Before the present compounds, compositions, articles, systems, devices, and/or methods are disclosed and described, it is to be understood that they are not limited to specific synthetic methods unless otherwise specified, or to particular reagents unless otherwise specified, as such may, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications are referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present invention is not entitled to antedate such publication by virtue of prior invention. Further, the dates of publication provided herein may be different from the actual publication dates, which can require independent confirmation.

### A. DEFINITIONS

As used in the specification and the appended claims, the singular forms “a,” “an” and “the” include plural referents unless the context clearly dictates otherwise. Thus, for example, reference to “a composition,” “a fiber,” or “a step” includes mixtures of two or more such functional compositions, fibers, steps, and the like.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “optional” or “optionally” means that the subsequently described event or circumstance can or can not occur, and that the description includes instances where said event or circumstance occurs and instances where it does not.

As used herein, the term “polymer” refers to a relatively high molecular weight organic compound, natural or synthetic, whose structure can be represented by a repeated small unit, the monomer (e.g., polyethylene, rubber, cellulose). Synthetic polymers are typically formed by addition or condensation polymerization of monomers. Homopolymers (i.e., a single repeating unit) and copolymers (i.e., more than one repeating unit) are two categories of polymers.

As used herein, the term “homopolymer” refers to a polymer formed from a single type of repeating unit (monomer residue).

As used herein, the term “copolymer” refers to a polymer formed from two or more different repeating units (monomer residues). By way of example and without limitation, a copolymer can be an alternating copolymer, a random copolymer, a block copolymer, or a graft copolymer. It is also contemplated that, in certain aspects, various block segments of a block copolymer can themselves comprise copolymers.

As used herein “fouling” refers to the deposition of organic matter on a membrane surface. Fouling includes, but is not limited to, the deposition of bacteria or algae on the water processing system membranes described herein.

As used herein, “feed stream” refers to seawater directed from a seawater filtration system to a high pressure monitoring cell.

As used herein, “permeate stream” refers to seawater that has been directed through an active side of a desalination membrane within a high pressure monitoring cell.

As used herein, “concentrate stream” refers to seawater that has been directed across an active side of a membrane within a high pressure monitoring cell.

As used herein “draw stream” refers to seawater that has been directed through an active side of a pressure retarded osmosis membrane within a high pressure monitoring cell.

As used herein, “brine stream” refers to the water of a sea or salt lake directed to a high pressure monitoring cell in a salt-gradient power system.

As used herein, “flux” refers to liquid flow across a unit area of membrane. Flux can be, but is not limited to, permeate flux or draw flux.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds can not be explicitly disclosed, each is specifically contemplated and described herein. For example, if a particular device is disclosed and discussed and a number of modifications that can be made to a number of the components are discussed, specifically contemplated is each and every combination and permutation of the device and the modifications that are possible unless specifically indicated to the contrary. Thus, if a class of components A, B, and C are disclosed as well as a class of components D, E, and F and an example of a combination device, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the devices of the invention. Thus, if there are a variety of additional steps that can be performed it is understood that each of these additional steps can be performed with any specific embodiment or combination of embodiments of the methods of the invention.

### B. METHODS FOR DETECTING MEMBRANE FOULING

Described herein are methods for detecting membrane fouling in a membrane-based water processing system, the method comprising: providing a high pressure monitoring cell in parallel with the water processing system, the cell comprising a membrane; passing a sample side-stream from a feed stream or a brine stream of the water processing system through the membrane cell at an ambient feed or brine stream pressure, thereby generating a differential pressure along the membrane length, generating a transmembrane pressure drop through the membrane, and generating a membrane flux through the membrane; and measuring one or more of: differential pressure, wherein an increase indicates fouling of the water processing system membrane, transmembrane pressure drop, wherein an increase indicates fouling of the water processing system membrane, and flux, wherein a decrease indicates fouling of the water processing system membrane. A membrane-based water processing system can be any water purification system known in the art. For example, and not to be limiting, a membrane-based water processing system can be a desalination system, a pressure retarded osmosis (PRO) osmotic power generating system, or a reverse electrodialysis salinity gradient power system.

In one aspect, the methods described herein can be used to detect membrane fouling in a membrane-based desalination system, the method comprising: providing a high pressure monitoring cell in parallel with the desalination system, the cell comprising a membrane; passing a sample side-stream from a feed stream of the desalination system through the membrane cell at an ambient feed stream pressure, thereby generating a differential pressure along the membrane length, generating a transmembrane pressure drop through the membrane, and generating a permeate flux through the membrane; and measuring one or more of: differential pressure, wherein an increase indicates fouling of the desalination membrane, transmembrane pressure drop, wherein an increase indicates fouling of the desalination membrane, and permeate flux, wherein a decrease indicates fouling of the desalination membrane.

In a further aspect, the methods described herein can be used to detect membrane fouling in a membrane-based salinity-gradient power system, the method comprising: providing a high pressure monitoring cell in parallel with the salinity-gradient power system, the cell comprising a membrane; passing a sample side-stream from a brine stream of the salinity-gradient power system through the membrane cell at an ambient brine stream pressure, thereby generating a differential pressure along the membrane length, generating a transmembrane pressure drop through the membrane, and generating a draw flux through the membrane; and measuring one or more of: differential pressure, wherein an increase indicates fouling of the salinity-gradient power system membrane, transmembrane pressure drop, wherein an increase indicates fouling of the salinity-gradient power system membrane, and draw flux, wherein a decrease indicates fouling of the salinity-gradient power system membrane.

In one aspect, the sample feed stream or brine stream can be passed through the membrane by using a high pressure pump. A backpressure regulator and a needle valve can be used to control the flow rate and feed pressure for the monitoring cell.

In one aspect, the methods described herein can comprise measuring only the differential pressure. In a further aspect, the methods described herein can comprise measuring only the transmembrane pressure drop. In yet a further aspect, the methods described herein can comprise measuring only the flux. In one aspect, flux can be permeate flux. In a further aspect, flux can be draw flux.

In one aspect, the methods described herein can comprise measuring all three of the differential pressure, transmembrane pressure drop, and flux. In a further aspect, the methods described herein can comprise measuring differential pressure and transmembrane pressure drop. In yet a further aspect, the methods described herein can comprise measuring differential pressure and flux. In still a further aspect, the methods described herein can comprise measuring transmembrane pressure drop and flux are measured.

In one aspect, the methods described herein can comprise measuring permeate stream water quality. For example, and not to be limiting, water quality data can be generated by measuring permeate conductivity. In one aspect, permeate conductivity can be measured by applying a voltage to a pair of electrodes immersed in a permeate solution.

In one aspect, the sample feed stream from the seawater filtration system can be passed through the membrane of the cell at a stream feed pressure of at least about 300 psi. For example, and not to be limiting, the sample side-stream feed stream or brine stream from the water processing system can be passed through the membrane of the cell at a stream feed pressure of 300 psi, 350 psi, 400 psi, 450 psi, 500 psi, 550 psi, 600 psi, 650 psi, 700 psi, 750 psi, 800 psi, 850 psi, 900 psi, 950 psi, 1000 psi, 1050 psi, 1100 psi, 1150 psi, 1200 psi, or greater than 1200 psi, or any pressure in between.

In one aspect, the membrane-based water processing system described herein can comprise at least one reverse osmosis membrane. In a further aspect, the membrane-based water processing system can comprise at least one forward osmosis membrane. In yet a further aspect, the seawater filtration system can comprise at lease one nanofiltration membrane. In still a further aspect, the seawater filtration system can comprise at least one pressure retarded osmosis membrane. For example, and not to be limiting, the membrane-based water processing system can comprise two nanofiltration membranes for use in a two-pass nanofiltration desalination process.

In one aspect, the sample feed stream can be operated in parallel with a full scale seawater desalination plant such that a side stream of feed solution can be directed to the high pressure monitoring cell. The conditions in the high pressure monitoring cell can be adjusted so that the conditions are equivalent to the conditions in the full scale seawater desalination system. In a further aspect, the sample feed stream can undergo pretreatment prior to passing through the high pressure monitoring cell. For example, and not to be limiting, the sample feed stream can be directed through a microfiltration membrane and a cartridge filter prior to passing through the membrane of the high pressure monitoring cell. In one aspect, the microfiltration membrane can be a 0.1 μm microfiltration membrane and the cartridge filter can be a polypropylene filter with a 5 μm pore size. In yet a further aspect, the pretreatment can include a chlorination step followed by a dechlorination step.

In one aspect, the methods described herein can further comprise applying a chemical cleaning solution to recover the initial, unfouled performance of the water processing membrane. The chemical cleaning solution can be any chemical solution capable of cleaning water processing membranes. For example, and not to be limiting, the chemical cleaning solution can be a solution comprising NaOH, NaOCl, H₂O₂, peroxyacetic acid, citric acid, nitric acid, surfactants, or detergents. In a further aspect, the methods described herein can further comprise pretreatment of the water processing membrane. For example, and not to be limiting, the membranes described herein can be pretreated with ClO₂ to prevent or mitigate membrane fouling. Therefore, the methods described herein can comprise measuring one or more of differential pressure, transmembrane pressure drop, and flux after applying the chemical cleaning solution or after pretreating the water processing membrane with ClO₂.

In one aspect, one or more of an increase in differential pressure, an increase in transmembrane pressure drop, and a decrease in flux can be determined by comparison to a differential pressure, transmembrane pressure drop, or flux of an unfouled reference membrane.

In one aspect, one or more of an increase in differential pressure, an increase in transmembrane pressure drop, and a decrease in flux can be determined by comparison to an initial, unfouled flux of the same membrane.

In one aspect, one or more of an increase in differential pressure, an increase in transmembrane pressure drop, and a decrease in flux can be determined by comparison of differential pressure, transmembrane pressure drop, or flux at a first time point to differential pressure, transmembrane pressure drop, or flux at a second time point.

In one aspect, the differential pressure, transmembrane pressure drop, and/or the flux can be measured over a predetermined time period.

In one aspect, the high pressure monitoring cell of the methods described herein can comprise: a membrane having a surface on an active feed side; and a flow head configured and arranged to direct a sample feed stream from the water processing system through the surface of the membrane and to thereby generate a concentrate stream on the active side of the membrane and a permeate stream opposite the active feed side of the membrane; and coupled to the cell, a means for measuring one or more of differential pressure, transmembrane pressure drop, and flux.

1. Operation of High Pressure Monitoring Cells

In one aspect, the high pressure monitoring cells described herein can operate as shown in FIG. 31. Further aspects of the high pressure monitoring cells are detailed below.

a. Differential Pressure

Differential pressure can be calculated using the formula: Pi−Po=axial pressure drop, “delta P” or “Δpx”, wherein Pi is the inlet, or feed stream, pressure and Po is the outlet, or concentrate stream, pressure. As used herein, “concentrate stream” can also mean “brine stream.” Pi and Po can be measured with any pressure detector known in the art. For example, and not to be limiting, Pi and Po can be measured with a pressure gauge or pressure transducer. As seawater desalination membranes become fouled, Pi can increase, and Po can decrease, thereby resulting in an increase in Δpx. Thus, measuring an increase in Δpx across the membrane of the high pressure fouling detectors described herein can indicate fouling of the sweater desalination membranes in the full scale desalination plant.

b. Transmembrane Pressure Drop

Transmembrane pressure drop can be calculated using the formula: ½(Pi−Po)−Pp=trans-membrane pressure, wherein Pi is the inlet, or feed stream, pressure, Po is the outlet, or concentrate stream, pressure, and Pp is the permeate stream pressure. As seawater desalination membranes become fouled, Pi can increase, and Po can decrease, thereby resulting in an increase in transmembrane pressure drop. Thus, measuring an increase in transmembrane pressure drop through the membrane of the high pressure fouling detectors described herein can indicate fouling of the sweater desalination membranes in the full scale desalination plant.

c. Permeate Flux

Permeate flux can be measured by any flow detector known in the art. For example, and not to be limiting, permeate flux can be measured by a digital liquid flow meter or a hydraulic flow meter. As seawater desalination membranes become fouled, permeate flux can decline. Thus, measuring a decrease in permeate flux across the membrane of the high pressure fouling detectors described herein can indicate fouling of the sweater desalination membranes in the full scale desalination plant.

### C. HIGH PRESSURE MONITORING CELLS

Described herein are high pressure monitoring cells for use in detecting membrane fouling in a seawater filtration system, the cell comprising a membrane having a surface on an active feed side; and a flow head configured and arranged to direct a sample feed stream or brine stream from the water processing system through the surface of the membrane and to thereby generate a concentrate stream on the active side of the membrane and a draw stream or permeate stream opposite the active feed side of the membrane; and coupled to the cell, a means for measuring one or more of differential pressure, transmembrane pressure drop, and flux. In one aspect flux can be draw flux. In a further aspect, flux can be permeate flux.

In one aspect, the high pressure monitoring cells described herein can be connected to the feed stream side of a desalination system, and enable the monitoring of changes in the desalination membranes. These changes include, but are not limited to, membrane fouling. Membrane fouling, if left unchecked, can lead to a reduction in permeate production and potential damage to the filtration membranes.

In one aspect, the high pressure monitoring cells described herein can be operated at least about 300 psi. For example, and not to be limiting, the cells can be operated at a pressure of 300 psi, 350 psi, 400 psi, 450 psi. 500 psi, 550 psi, 600 psi, 650 psi, 700 psi, 750 psi, 800 psi, 850 psi, 900 psi, 950 psi, 1000 psi, 1050 psi, 1100 psi, 1150 psi, 1200 psi, or greater than 1200 psi, or any pressure in between.

In one aspect, the flow head can comprise first substrate having an input port, or feed stream port, a concentrate stream port, and a cross flow channel configured to direct the feed stream through the active side of the membrane at about at least 400 psi, the substrate located adjacent the active side of the membrane; and the cell can further comprise: a second substrate having a permeate channel and permeate port, the substrate located opposite the active feed side of the membrane, and the permeate channel aligned with the cross flow channel; a feed-side detector coupled to the first substrate so as to interact with the feed stream; and a permeate-side detector coupled to the second substrate so as to interact with the permeate stream. In one aspect, the feed-side detector can be a hydraulic flow meter or a digital flow meter. In a further aspect, the permeate-side detector can be a hydraulic flow meter or a digital flow meter.

The first and second substrates can be plates made of any corrosion resistant material, including, but not limited to 316 stainless steel. The two plates can be bolted together with stainless steel screws. In one aspect, the feed stream port can be parallel to the concentrate port and each port can be located on opposite ends of the first plate. In a further aspect, grooves can be machined into the first plate to hold an o-ring gasket, which can be installed to prevent leaking. In still a further aspect, a membrane coupon can be placed between the two plates with the active side facing towards the first plate. The membrane can be any membrane known in the art of membrane-based water processing, including, but not limited to, an ultrafiltration membrane, a nanofiltration membrane, a reverse osmosis membrane, a forward osmosis membrane, or a pressure retarded osmosis membrane. In one aspect, the membrane of the high pressure monitoring cells described herein can have a permeate producing surface area of 424 cm².

In one aspect, the high pressure monitoring cell can further comprise a feed spacer located between the first substrate and the active side of the membrane; and a permeate spacer located between a surface opposite the active side of the membrane and the second substrate. The spacers in the high pressure monitoring cell can be matched to the spacers from the full scale seawater desalination plant. For example, and not to be limiting, the spacer thickness can be at least about 650 μm. The spacer can also be taken from a commercially available membrane, for example, and not to be limiting, an NF90 membrane.

Two rubber o-ring gaskets can be used to seal the cross flow channel. In one aspect, the cross flow channel can be 254 mm long and 50.8 mm wide, with a feed channel height of 650 μm. In a further aspect, the feed channel height of the cross flow channel can be adjusted according the thickness of the feed spacer from the full scale water processing plant. For example, and not to be limiting, when the thickness of the water processing membrane is 650 μm, the feed channel height of the cross flow channel can also be 650 μm.

In one aspect, the high pressure monitoring cells described herein can be operated in parallel with a full scale seawater desalination plant such that a side stream of feed solution can be directed to the high pressure monitoring cell. In one aspect, the high pressure monitoring cells can be located in front of the adjacent desalination membranes. The conditions in the high pressure monitoring cell can be adjusted so that the conditions are equivalent to the conditions in the full scale desalination system. In a further aspect, the sample feed stream can undergo pretreatment prior to passing through the high pressure monitoring cell. For example, and not to be limiting, the sample feed stream can be directed through a microfiltration membrane and a cartridge filter prior to passing through the membrane of the high pressure monitoring cell. In one aspect, the microfiltration membrane can be a 0.1 μm microfiltration membrane and the cartridge filter can be a polypropylene filter with a 5 μm pore size. In yet a further aspect, the pretreatment can include a chlorination step followed by a dechlorination step. In still a further aspect, the pretreatment can include ClO₂ to prevent and/or mitigating the fouling of the desalination membranes.

### D. EXPERIMENTAL

The following examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

1. Usage of High Pressure and Low Pressure Fouling Detectors to Simulate Full Scale Seawater Desalination Plant Performance

a. Materials and Methods

(1) High-Pressure Fouling Detector (NPFD)

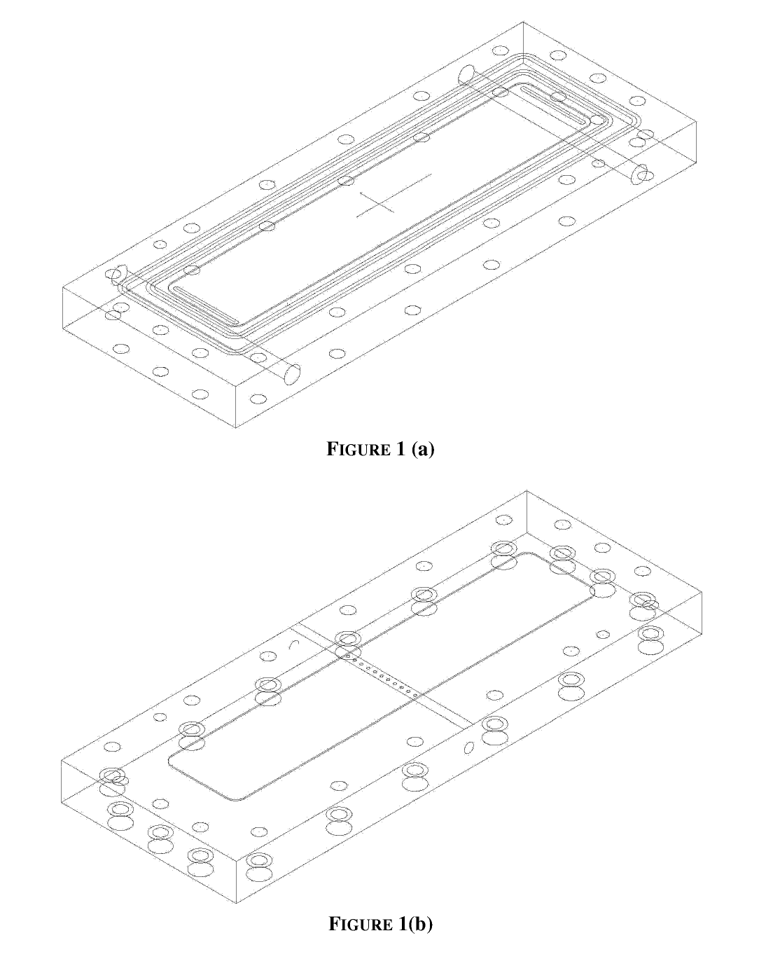

The high-pressure fouling detector was made of 316 stainless steel material and composed of two pieces: (1) a top plate providing feed and concentrate ports and the cross flow channel, and (2) a bottom plate containing the permeate channel and ports (FIG. 1). On the top plate, the feed port was parallel to the concentrate port each located on the opposite ends of the length of the plate. Two grooves were machined into the plate to hold the rubber o-ring gaskets that prevent leaking. The permeate port on the bottom plate was located in the center of the plate.

A membrane coupon was placed between the two plates with the active side facing towards the top plate. Feed spacer was placed in between the active side of the membrane and the top plate, and permeate spacer was placed in between the back side of the membrane and the bottom plate. The two plates were bolted together with 18 stainless steel screws on the edges. All of the wetted parts were made from 316 stainless steel material. Two concentric rubber o-ring gaskets sealed the flow channel. The flow channel was designed 254 mm long and 50.8 mm wide with a feed channel height of 650 μm, which matched the thickness of Pass 1 seawater NF membrane feed spacers from the full scale (NF 90, Dow Water Solutions, Midland, Mich.). The HPFD membrane surface area producing permeate was 424 cm².

(2) Low-Pressure Fouling Detector (LPFD)

The low-pressure fouling detector was made of PVC material and composed of two pieces: (1) a top plate providing feed and concentrate ports, the cross flow channel, and a view window, and (2) a smooth bottom plate piece. On the top plate, the feed port was parallel to the concentrate port each located on the opposite ends of the length of the plate. Two grooves were machined into the plate to hold the rubber o-ring gaskets that prevent leaking. The smooth bottom plate held the membrane to the top plate.

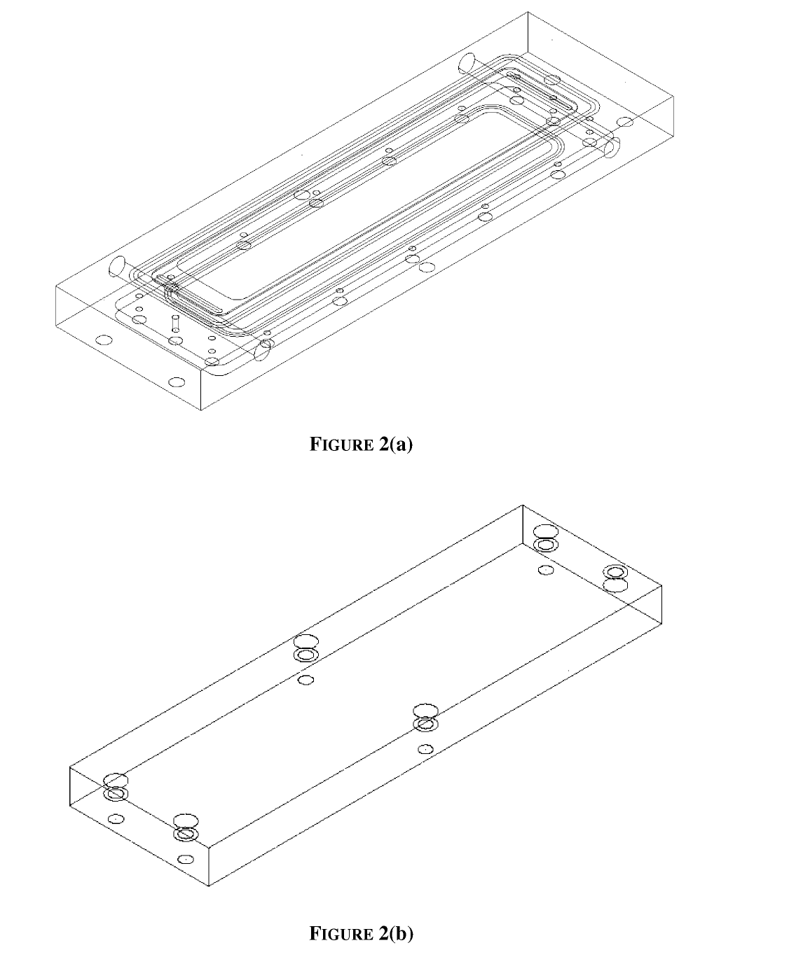

A membrane coupon was placed between the two plates with the active side facing towards the view window. Feed spacer was placed in between the active side of the membrane and the top plate. The LPFD did not have permeation, so the backside of the membrane was placed directly against the bottom plate. The two plates were bolted together with 6 stainless steel screws on the edges. All of the wetted parts were made of PVC. A single rubber o-ring gasket sealed the flow channel. The LPFD is shown in FIG. 2. The flow channel was designed to be 254 mm long and 50.8 mm wide with a feed channel height of 650 μm, which matched the thickness of the pass 1 SWNF membrane feed spacer.

(3) Commercial Membrane Fouling Simulator (MFS)

A low pressure SMO254 stainless steel MFS (type 1) was purchased from Kiwa Water Research (the Netherlands) to compare the performance of the HPFD and LPFD fouling detectors with a commercial fouling simulator. The MFS was composed of two pieces: (1) a top plate providing feed and concentrate ports, the cross flow channel, a view window, and (2) a smooth bottom plate piece. A membrane coupon was placed between the two plates with active side facing towards the view window. The feed spacer was placed in between the active side of the membrane and the top plate. The two plates were bolted together with 12 stainless steel screws. Rubber o-ring gaskets sealed the membranes around all the screws. The flow channel was designed to be 200 mm long and a width of 40 mm wide with a feed channel height of 0.78 mm. Silicone adhesive was applied to seal the MFS. The use of adhesive may have reduced the feed channel height.

(4) Experimental Set Up

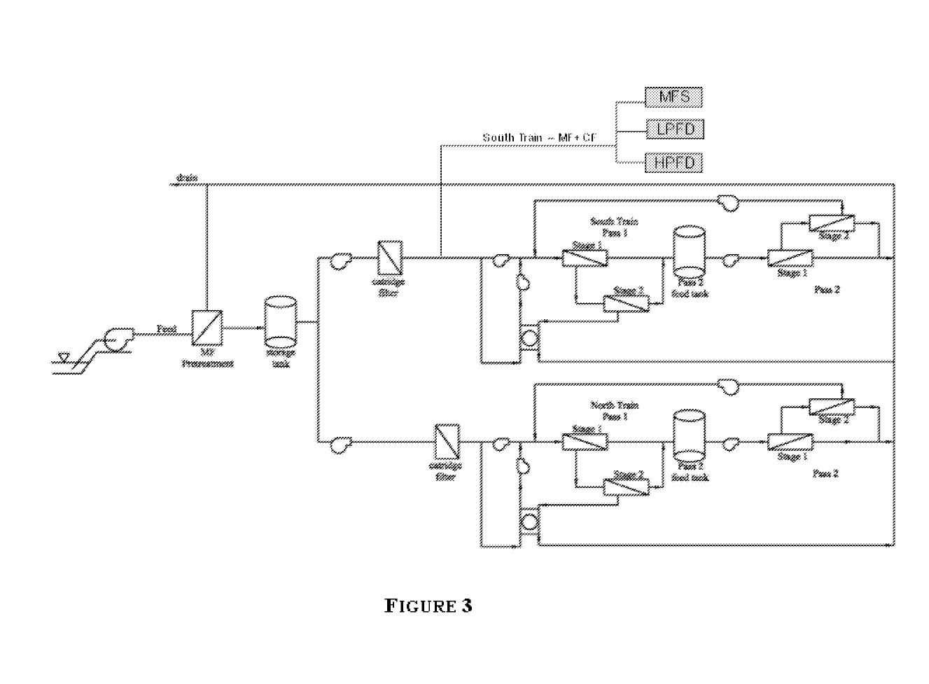

After the low-pressure and high-pressure fouling detectors were designed and constructed, along with a commercial MFS, they were installed in the field at the LBWD prototype desalination plant. The source water underwent several pretreatment processes before the desalination membranes, including trash racks at the channel intake to screen out coarse materials, 300 μm self-backwashing strainers prior to chlorination with sodium hypochlorite, and filtering through 0.1 μm microfiltration (MF) membranes (Pall Microza, East Hills, N.Y.) (FIG. 3). Water exiting the MF filtrate tank was de-chlorinated using sodium bisulfate to achieve a chlorine residual of <0.1 mg/L. After dechlorination, the feed water passed through cartridge filters (CFs) before feeding into the membrane vessels. No anti-scalants or acid were dosed to the NF feed water. The cartridge filters (CF) (Claris, PALL Corporation, East Hills, N.Y.) were polypropylene with a nominal 5 μm pore size. The cartridge filters were replaced when the differential pressure across the filters reached 15 psi. The CFs were replaced 2 times during this experiment (day 40 and 76 of the research period).

The full scale SWNF installation consisted of 1 stage of 10 parallel pressure vessels; each pressure vessel contained 5 membrane elements of 40″ length. The NF plant recovery was 36%. The feed water pressure was 550 psi, equal to the HPFD flow cell feed pressure.

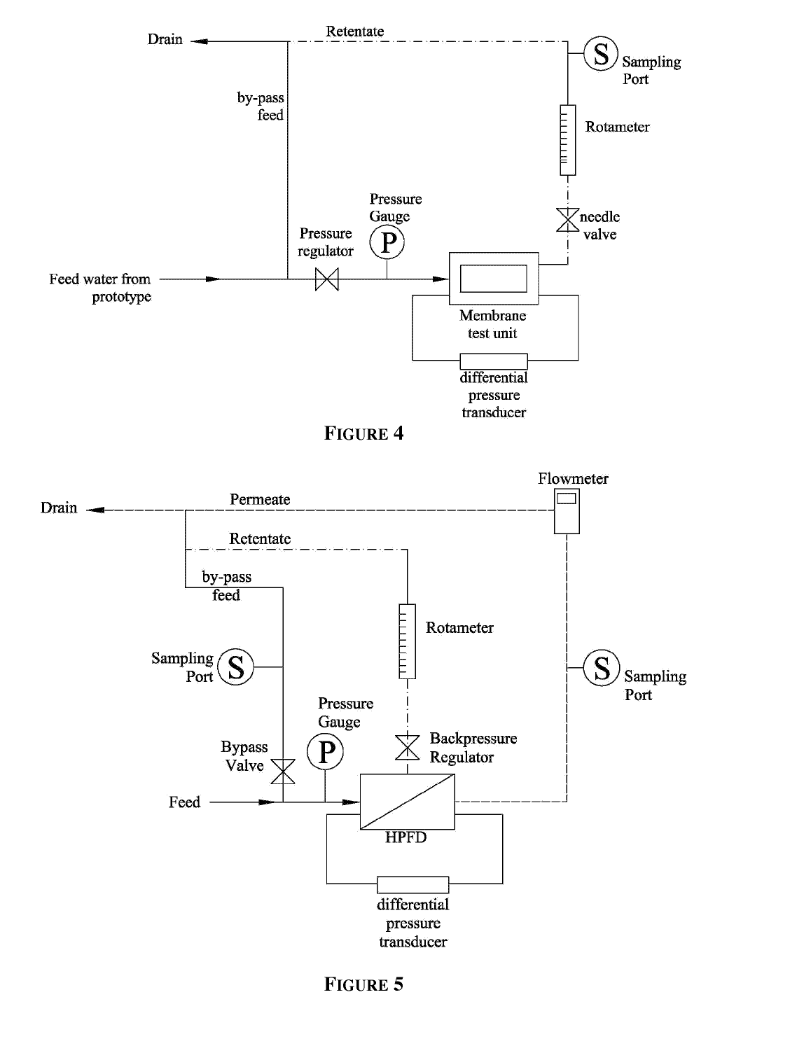

The LPFD and MFS were designed to operate at low pressure and detect membrane fouling through changes in the differential pressure (FIG. 4). Feed water from the prototype entered through a pressure reducing valve (Plast-O-Matic, Cedar Grove, N.J.) that kept the pressure constant at 41.4 kPa (6 psi). Flexible tubing was used to connect the inlet and outlet of the detectors to the differential pressure transducer. The flow rate was controlled by a needle valve at the outlet of the detectors and monitored using a rotometer. The flow rate of the experiment was calculated so that it simulated the same Reynold's number of the prototype plant. The viewing windows of the detectors were covered with black plastic sheets to protect the membranes from exposure to sunlight.

The HPFD was operated at high-pressure (550 psi) (FIG. 5). Because the feed water from the MF feed tank was not at high pressure, an additional feed tank and high-pressure pump (Hydracell, Wanner Engineering, Minneapolis, N.Y.) were needed to match the full-scale plant operating pressure. A backpressure regulator (Swagelok, Camarillo, Calif.) and needle valve (Swagelok, Camarillo, Calif.) controlled flow rate and feed pressure for each detector. Feed flowrate was measured by a hydraulic flow meter (King Instrument, Garden Grove, Calif.). The permeate flow was monitored by a digital flow meter (Tovatech, South Orange, N.J.).

(5) Operating Characteristics of Fouling Detectors

In order to operate the fouling detectors to simulate the full-scale plant, the Reynolds' number of the plant cross flow was matched. Using full size plant feed flow and number of elements, leafs per elements, and spacer geometry as inputs, the feed flow per membrane feed channel was calculated. This feed flow rate was the full size plant influent split between the 2 trains, divided among the parallel spiral wound elements in each stack, and then, divided by the number of leafs per element. The operating parameters are shown in Table 1.

TABLE 1

| | | Cross | | | | Feed |
|---|---|---|---|---|---|---|
| | Feed | flow | Permeation | | | spacer |
| | flow | velocity | velocity | | Membrane | thickness |
| | (m³/h) | (m/s) | mm/s | Re | type | (μm) |
| Simulation | 0.0114 | 0.089 | 0.0 | 96 | NF | 650 |
| model | | | 4.0 | | NF | 650 |
| | | | 8.0 | | NF | 650 |
| Prototype | 0.1535 | 0.102 | 3.8 | 96 | NF | 650 |
| (lead | | | | | | |
| module) | | | | | | |
| MFS | 0.0104 | 0.087 | no | 96 | NF | 780 |
| HPFD | 0.0114 | 0.102 | 6.8 | 96 | NF | 650 |
| LPFD | 0.0114 | 0.102 | no | 96 | NF | 650 |

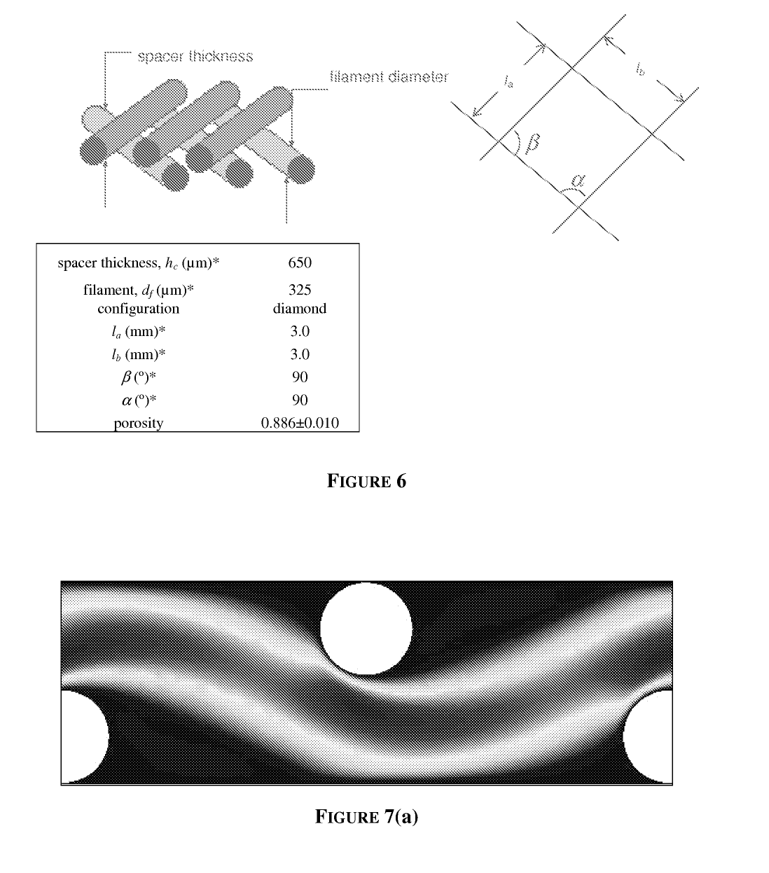

Channel height was defined from the total spacer thickness. Total active area, channel length, and channel width of the membrane were measured as previously described. The actual membrane length and width minus the glue line was taken into account. The membrane length and width was the manufacturer's specification minus ˜0.5 inches of glue line from two sides. Total active area was the actual length multiplied by the actual width. The feed spacer geometry is shown in FIG. 6 with spacer porosity having a margin of error at 0.01.

Average porosity of the feed spacer was measured as follows. Several feed spacer with various different area was cut and each was submerged in DI water in a graduated cylinder. The difference in DI water volume with and without feed spacer inside was the solid volume of the feed spacer. The void volume was the total volume of feed spacer (area×thickness) minus the solid volume. The porosity was the void volume divided by the total volume. Cross sectional area of the channel, A_{f} was:

A_{f}=channel width/channel height/porosity (2.1);

Cross flow velocity of the channel in a full-scale plant was: u_{f}=Q_{f}/A_{f} (2.2);

Specific surface area of spacer was calculated from: S=4/channel height (2.3); hydraulic diameter was

$${d}_{h} = \frac{4 ɛ}{2 h + S ( 1 - ɛ )} ; \qquad ( 2.4 )$$

Here, Reynolds number (Re), Sherwood number (Sh), and mass transfer coefficient (k) were calculated from:

$$\begin{matrix}Re = \frac{{u}_{f} {d}_{h}}{v} ; & ( 2.5 ) \\ Sh = 0.065 {Re}^{0.875} {Sc}^{0.25} ; & ( 2.6 ) \\ k = \frac{ShD}{{d}_{h}} . & ( 2.7 )\end{matrix}$$

Active area of membrane in the fouling detectors was the length of the channel multiply by the width. Cross sectional area of the laboratory scale channel was

Aₗ=width/height/porosity (2.8).

Specific surface area, S and hydraulic diameter, dₕ of the laboratory scale channel was the same equations (2.3) and (2.4) for the full-scale but using laboratory scale dimensions.

All fouling detectors were operated at the same Reynolds number as the full size plant's Reynolds number at the inlet side of the lead module. To calculate the necessary parameters, the following steps were taken:

a. The laboratory scale Reynolds number was set to be the same as the full size plant's lead module Reynolds number.

b. Equations (2.6) and (2.7) were used to find Sherwood number, and mass transfer coefficient, respectively.

c. Rearrange Equation (2.5) was used to find cross flow velocity.

d. Equation (2.2) was used to find the feed flow rate for the fouling detectors using channel area from Equation (2.8).

(6) Hydrodynamic Simulation of Fouling Detectors

Flow within the fouling detectors was analyzed using a previously developed hydrodynamic model solved using a commercial finite element method-based solver (FEMLAB 3.0, Comsol Inc., Sweden). The hydrodynamic model represented a two-dimensional cross section of the leading 30 mm of the fouling detectors. Model parameters were based on hydrodynamic conditions in the fouling detectors with an inlet cross flow velocity of 0.089 m/s to match the full-scale lead module Reynold's number and permeation velocities of 0, 4.0 and 8.0 μm/s. Spacer filament geometry and orientation in the flow channel were adapted from the actual feed spacer geometry used in the fouling detectors. The spacer used in the experiment was taken from a commercially available membrane (NF 90, Dow Water Solutions, Midland, Mich.).

b. Results

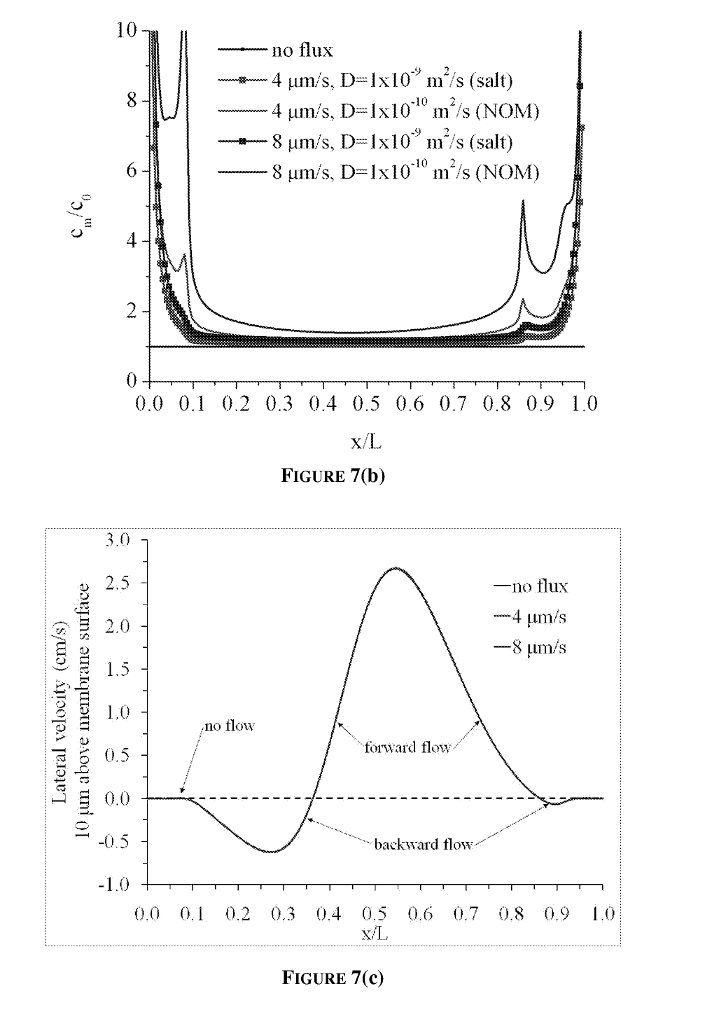

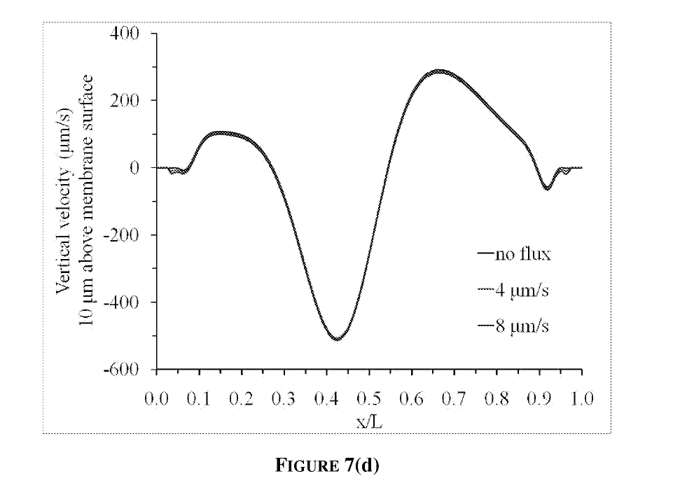

The simulated flow field is shown in FIG. 7a. A short region between two spacer filaments in the simulated fouling detector (enlarged in FIG. 7a) was further analyzed for differences in transport due to hydrodynamics and solute properties. Solute concentration at the membrane surface is shown in FIG. 7c for model solutes assuming complete rejection. Solute concentration at the membrane surface increased with increasing flux and decreasing diffusion coefficient. Macro molecule concentration near the spacer was higher than the dissolved species. Solute concentrations were elevated dramatically near the spacer filaments. This suggested that salts and dissolved organics were more likely to accumulate on the back side of the spacer filaments on the membrane surface. The no flux scenario in the low-pressure detector was represented by the black line, which indicates no concentration difference throughout the channel.

Simulations of flow in the fouling detectors revealed very little difference in both lateral and normal flow profiles for channels simulated with and without permeation 10 μm above the membrane surface (FIGS. 7c and 7d). The lateral velocity showed a negative (backward) velocity near the membrane after the spacer filament (arrow in FIG. 7a). The vertical velocity 10 μm above the membrane was predominantly generated by cross flow being redirected vertically by the spacer. There was a net negative (downward toward the membrane) vertical velocity after the area where the negative lateral velocity existed at around x/L=0.4. In between the spacer filament, the greatest driving force was a downward velocity. This showed a difference in how the different sizes of particles accumulated on the membrane surface. Permeation had little effect on solute transport beyond 10 μm from the membrane surface. However, flux did increase solute concentration at the membrane surface.

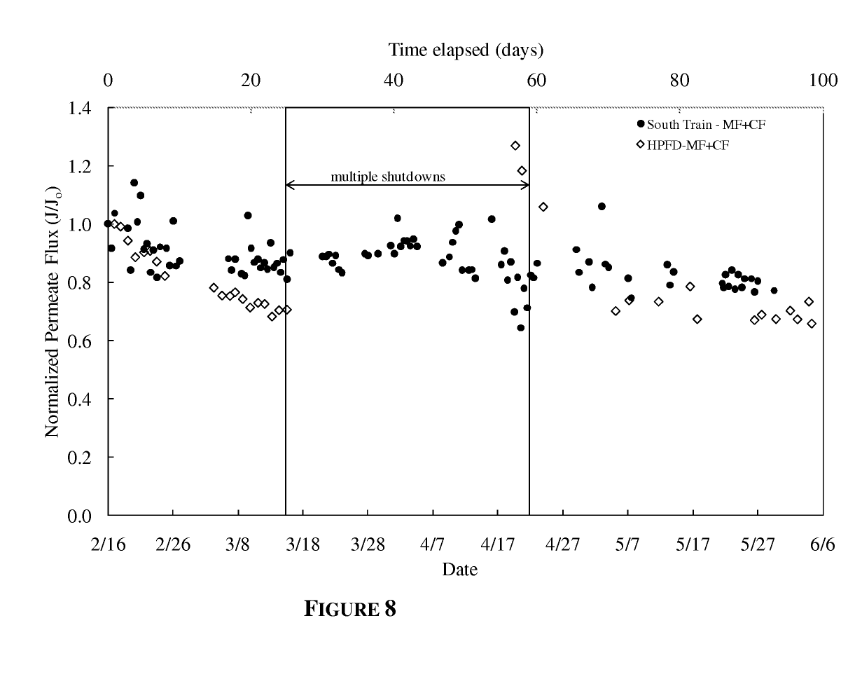

When the HPFD was operated in parallel with the full-scale plant, both permeate fluxes were calculated and compared to each other (FIG. 8). The data showed that the permeate flux for both the detector and the full-scale plant followed a similar pattern. Discrepancies in flux data were due to multiple system shutdowns during the testing period. When the experiment was restarted, the permeate flux stabilized to the same concentration as before. A feed pressure of 550 psi resulted in a HPFD flux of 26 LMH (424 cm² membrane surface area and permeate flow of 322 ml/h).

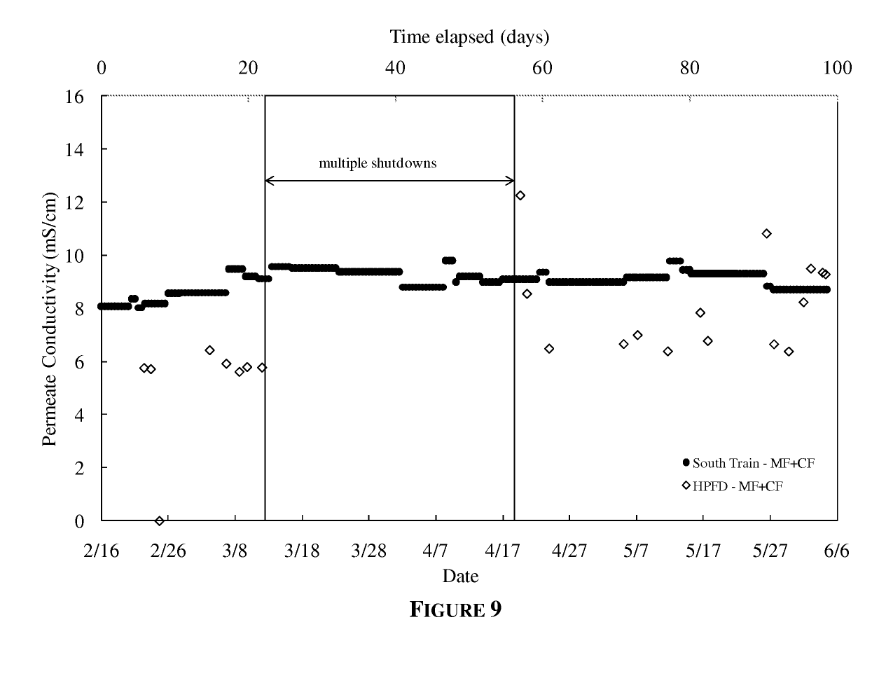

Aside from the permeate flux, the high-pressure detector was also capable of generating product water quality data (FIG. 9). The permeate conductivity from the detector was compared to the south train; it became apparent that both data followed similar trends. The high-pressure fouling detector had slightly lower permeate conductivity than the south train since it only represented the first 12 inches of the full-scale plant where feed flow and permeate flux were highest, and hence, permeate conductivity was the lowest due to the “dilution effect”.

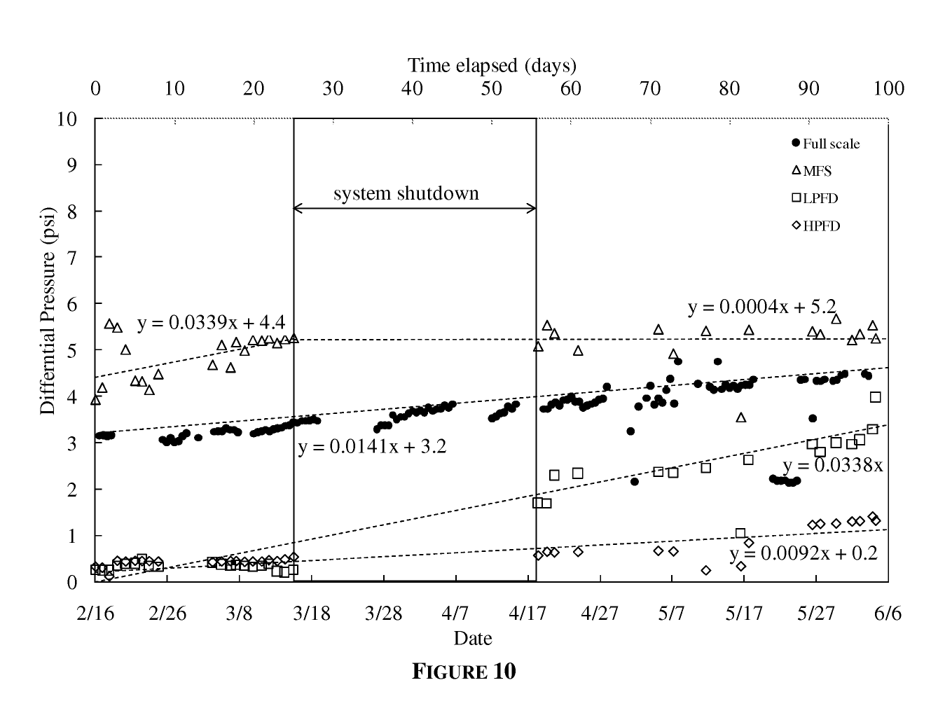

In FIG. 10, the low-pressure and high-pressure detectors and the MFS were operated side by side with the full scale installation. Differential pressures (ΔP) between inlet and outlet were recorded from the simulators. The feed channel pressure drop over the full scale installation (containing 5 elements in series) showed a gradual increase in time. Repeatedly, a temporary decline of feed channel pressure drop was observed (indicated with arrows in FIG. 10), suggesting cleanings. However, no cleanings had been applied. The MFS showed an initial pressure drop which was clearly higher than the pressure drop over the full-scale and the LPFD and HPFD monitors (FIG. 10). The MFS pressure drop increased rapidly and strongly during the first 25 days after starting the study and was stable in the period day 55 to 100. The LPFD and HPFD monitors showed a gradual increase in pressure drop during the 100 day study. The HPFD showed a lower pressure drop increase than the LPFD and a relative stable pressure drop in the period 90 to 100 days.

The pressure drop was directly related to the length (Schock and Miguel, 1987). Mathematically the pressure drop is expressed as

$$Δ p = λ \cdot \frac{ρ \cdot {v}^{2}}{2} \cdot \frac{L}{{d}_{h}} , \qquad ( 3.1 )$$

where λ is the friction coefficient, ρ the specific liquid density, v the linear velocity, L the length of the membrane or MFS and dh the hydraulic diameter. The length was the main difference between the full scale installation and the monitors MFS, HPFD and LPFD. The friction coefficient as given by the correlation function by Schock and Miguel (1987) was:

λ=6.23·Re^{-0.3} (3.2),

where Re is the Reynolds number, which was constant in this study (Table 1). Therefore, the pressure drop of the full-scale, MFS and LPFD and HPFD were normalized to the same length (division through respectively 500, 20 and 25.4 cm).

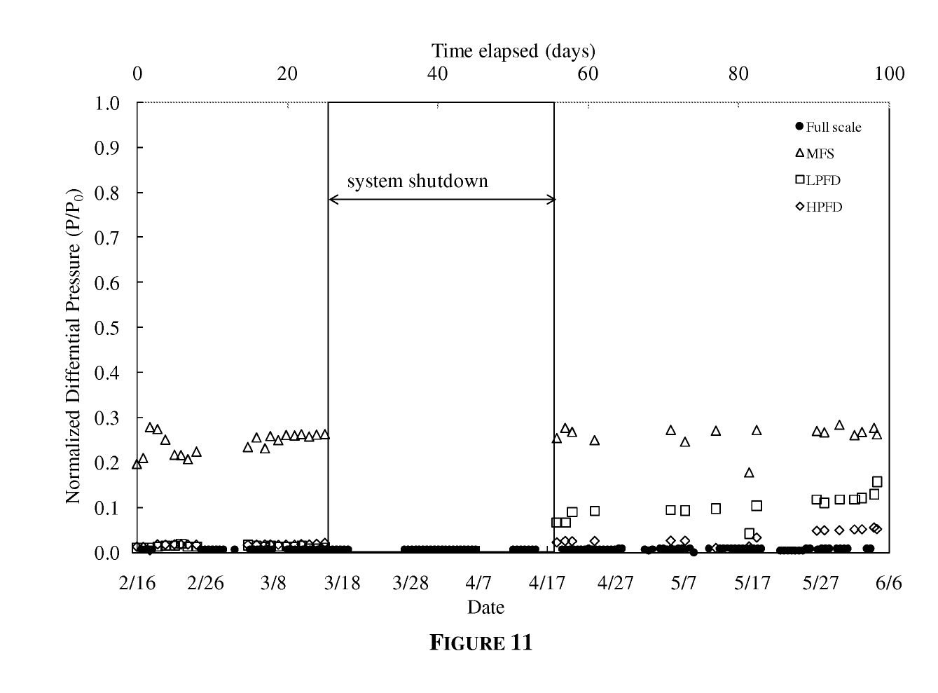

The normalized pressure drop data are shown in FIG. 11. The HPFD showed a more rapid pressure drop increase compared to the full-scale installation. A mathematical regression line was employed to estimate the slope of the differential pressure performance of all pressure detectors and the full-scale plant.

C. Discussion

The study objective was to evaluate the performance of the full scale seawater nanofiltration installation and the monitors MFS, LPFD and HPFD to come to an early warning system. The full scale seawater desalination installation showed a gradual performance reduction in time: a flux decline (FIG. 8) and feed channel pressure drop increase (FIG. 10). The HPFD showed a faster performance reduction (FIGS. 8 and 10) compared to the full-scale, suggesting that most fouling occurred in the first membrane element.

(1) Feed Channel Pressure Drop Increase

There was a gradient of linear feed flow velocities over the full scale installation. With increasing distance to the installation feed side the linear flow velocity was reduced as a consequence of permeate production. The pressure drop also varied over the membrane installation. The highest pressure drop was observed over the lead module. Biofouling and particulate fouling was observed in installation lead module first half, indicating that a small monitor can serve as early warning system. The full scale and the monitors had different lengths: the full-scale length was 500 cm, the MFS 20 cm, and the HPFD and LPFD both were 25.4 cm. To evaluate the monitors as early warning system, the pressure drop was normalized to the same length (FIG. 11).

(2) Flux Decline

In order to operate the fouling monitors at the same pressure as the full scale plant, they needed to be able to withstand high pressure. The HPFDs were designed, constructed, and operated differently compared to the LPFDs and the MFSs. When the HPFD was operated in parallel with the full scale plant, the data showed slightly faster flux decline than the full scale plant. This was because the HPFD represented the first 10 inches of the lead element where fouling occurred the most (FIG. 8).

(3) Early Warning System

An early warning system detected fouling earlier than the full scale installation, enabling early control measures. Control measures at an early stage of fouling were more effective than at a later stage.

2. Analysis of Various Seawater Desalination Pretreatment Processes Using High Pressure and Low Pressure Fouling Detectors

a. Materials and Methods

(1) Fouling Detectors and Experimental Set Up

Two types of fouling detectors were designed, constructed, and installed throughout the LBWD prototype seawater desalination plant. The low pressure fouling detectors (LPFDs) were designed to operate at 6 psi and detect membrane fouling via the differential pressure. They were designed without permeation through the membrane but with a clear plastic view window above the membrane for direct observation. The high pressure fouling detectors (HPFDs) were designed to be operated at 550 psi, and they had permeation through the membrane.

After the LPFDs and HPFDs were designed and constructed, they were installed in the field at the LBWD prototype desalination plant (FIG. 12). The prototype consisted of two trains; the north train and the south train. The plant was operated under varied conditions depending on the phase of the project. The number of elements in parallel and in series inside each train were varied during operation, which greatly affected the permeate flow or the product water quality. This was important because the different phases of the project caused sudden changes in the plant performance.

In order to operate the fouling detectors to simulate the prototype plant, the Reynolds' number of the prototype plant was matched. Using prototype plant feed flow and number of elements, leafs per elements, and spacer geometry as inputs, the feed flow per element was calculated. This feed flow rate was the full size plant influent which was split between the two trains and then divided among the parallel spiral wound elements in each stack.

(2) Pretreatment Types

The source water underwent several pretreatment processes before the desalination membranes, including trash racks at the channel intake to screen out coarse materials, 300 μm self-backwashing strainers prior to chlorination by sodium hypochlorite and a 0.1 μm microfiltration (MF) system (Pall Microza, East Hills, N.Y.). Water exiting the MF filtrate tank was de-chlorinated using sodium bisulfate to achieve a chlorine residual of <0.1 mg/L. After dechlorination, the feed water was split into two feed tanks where each tank fed the north train and the south train.

Ultraviolet (UV) radiation (TrojanUV, Ontario, Canada) was operated to disinfect the feed water into the north train for 60 operating days. The UV radiation was operated at intensity of 31 mJ/cm². For 54 operating days, chlorine dioxide was injected into south train. The chlorine was generated using the acid—chlorite method as shown below.

5NaClO₂+4HCl→4ClO₂(g)+5NaCl+2H₂O (13)

The chlorine dioxide generator was built and installed by Prominent (Pittsburg, Pa.). This yielded “Chlorine-free” chlorine dioxide (ClO₂). The chlorine dioxide was added into the trains at a residual concentration of 0.5 mg/L.

After the ClO₂ addition on south train and UV radiation on north train, the feed water passed through cartridge filters (CFs) before feeding into the membrane vessels. The cartridge filters (Claris, PALL Corporation, East Hills, N.Y.) were polypropylene material with a nominal 5 μm pore size. The cartridge filters were replaced when the differential pressure across the filters reached 15 psi.

On one of the fouling detectors, a granular activated carbon filter (GAC, PHP Micro-Carbon II, Pall Corporation, East Hills, N.Y.) was used as an additional pretreatment in attempt to remove organics from feed water for the bench scale experiment. Water quality from each pretreatments were collected (Table 2), and it was observed that the nutrient content of the feed water from all pretreatment yielded similar nutrient content.

TABLE 2

| | Raw | MF | | | | |
|---|---|---|---|---|---|---|
| | seawater | permeate | MF + CF | MF + GAC | MF + CF + UV | MF + CF + ClO₂ |
| TKN (mg/L) | 0.267 | 0.236 | 0.238 | 0.270 | 0.248 | 0.282 |
| Total P (mg/L) | 0.070 | 0.070 | 0.070 | 0.073 | 0.058 | 0.064 |
| TOC (mg/L) | 1.069 | 1.018 | 1.488 | 1.675 | 1.408 | 1.668 |

(3) Solids and ICP Analyses

Membranes in fouling detectors were taken out at the end of the test for examination of solids and for ICP analyses. Measurements of total and combustible solids were carried out based on Standard Method 2540D. In this procedure, 45 square inches of membrane area was scraped using a sterile blade. The solids removed from the surface of the membrane by the blade were rinsed into ceramic dishes. The samples were then dried in the oven for 24 hours at 105° C., cooled and weighed. Ceramic dishes were then placed in a furnace at 550° C. for 1 hour, cooled, and reweighed. The dry weight (after oven drying) gave the total solids. Total solids minus the mass of solids remaining after the furnace (non-volatile solids) gave the volatile solids.

Digested samples of extracted solids were analyzed by inductively coupled plasma optimal emission spectrometry, ICP-OES, (Model TJA Radial IRIS 1000 ICP OES, Perkin Elmer; Waltham, Mass., USA) following acid digestion using HNO₃/HC; (Standard Method 3030E-Recoverable). In preparing ICP analysis, the solids were scraped from the surface of the membrane and rinsed into a 100 mL beaker. Inside the beaker, 2 mL (1:1 HNO₃) and 10 mL (1:1 HCl) were added to the suspension. The suspension was heated on a hot plate until sample was reduced to ˜40 mL, making certain the water did not boil. The sample was cooled, filtered (0.45 μm membrane), and transferred to a volumetric flask where the volume was adjusted to 50 mL with deionized water. The “Multielement Standard US EPA (23 elements)” (GFS Chemicals, Powell, Ohio, USA) with multiple dilution (1, 5, 10, 20 mg/L) was used to provide standards for the ICP analysis.

(4) Biofilm Density and Thickness

Biofilm thickness and bacterial density on membrane surface were examined on small sections of membrane from the detectors. In addition to the flat sheet membrane, the lead elements from both south and north train of the prototype plant were also collected at the end of testing. Membrane elements were opened at UC Irvine Biological Machine Shop, and sectioned into 1 cm×1 cm square pieces, stained using SYTO 9 green-fluorescent nucleic acid stain and propidium iodide red-fluorescent nucleic acid stain following manufacturer's protocol (FilmTracer™ LIVE/DEAD Biofilm Viability Kit, Invitrogen, San Diego). After drying, the stained membranes were examined under Laser Scanning Confocal Microscope (Zeiss LSM 510 META) using two excitation/emission wavelength settings, at 488 nm/500 nm for SYTO 9 and 510 nm/635 nm for propidium iodide. Images were captured under each excitation/emission setting. Z sectioning method was used to determine the thickness of the biofilm. Bacterial density was evaluated by visually counting the number of cells attached to the membranes surface, and was determined by the average count number of 3 images for each sample.

(5) Fouling Organisms On Membrane

The foulant on membrane surface was eluted from 10 cm×10 cm sections of membrane using phosphate buffered saline (PBS, pH 7.0). Only the membranes from south and north train were used for fouling organism identification because the flat sheet membranes had limited area available for different tests conducted. The details of bacteria elution, concentration and total genomic DNA extraction protocols were reported earlier (Zhang et al. 2010).

For bacterial identification, microbial community DNA was amplified using universal 16S rRNA gene primers (Long et al.) and cloned into a pGEM-T cloning vector according to the manufacturer instructions (Promega, USA). Approximately 80 colonies of ampicillin-resistant transformants were randomly picked and cultured overnight in LB broth containing 50 mg/mL ampicillin. Plasmids were isolated using the plasmids purification kit (Qiagen Inc.CA), then used as templates for PCR amplification using pGEM-T-specific primers M13F and M13R. The plasmid that gave the desired size amplicon was then subjected for restriction fragment length polymorphism (RFLP) analysis using restriction endonucleases MspI and RsaI (Promega, USA). Plasmids that produced the same RFLP pattern were grouped together and considered members of the same operational taxonomic units (OTUs), and the frequency of each OTU was used as an indicator of bacterial species abundance.

Each OTU from the clone library was then sequenced using the M13F primer. The DNA sequencing was performed using the BigDye 3.1 sequencing kit following manufacturers' protocols (Applied Biosystems). The final reactions were submitted to Laragen, Inc. (Los Angeles, Calif.) for sequencing run using ABI prism 3100 capillary sequencing. Nucleotide sequences were submitted to BLAST search engine at NCBI GenBank database and identified through the similarity values. To construct a phylogenetic tree, sequences obtained were aligned with reference sequences retrieved from GenBank database, the distance matrices were calculated using ClustalX software and phylogenetic tree was produced by TreeView.

b. Results and Discussions

(1) Data Performance

Both south and north trains were operated parallel with the HPFDs and the LPFDs. Since the LPFDs were without permeation, only permeate flux and permeate conductivity for HPFDs were available for comparison with the prototype membrane data. FIG. 13 shows a comparison of the data performance from all the detectors with the full scale plant. The initial permeate conductivity (FIG. 13a) for the two full scale trains was different due to different membrane configurations inside the vessels.

The permeate conductivity for HPFD MF+CF+ClO2 which represented the ClO₂ exposed feed water remained low initially until a sudden increase. The change in permeate water quality happened after a prolong system shut down due to mechanical malfunction. During this shutdown, feed water containing ClO₂ remained stagnant in the fouling detectors and the prototype plant. This decrease in permeate water quality was only observed in the fouling detector, but not in the prototype plant (south train), suggesting membrane degradation happened in the HPFD but did not have a significant impact on the prototype plant (or the degradation was insignificant to impact water quality). The permeate conductivity for both UV and GAC pretreated feed water remained low and stable.

Normalized permeate flux data (FIG. 13b) was important to detect significant fouling or membrane degradation. The permeate flux for HPFD MF+CF+ClO2 started steady but it increased about the same time that the permeate conductivity increased in FIG. 13a. The increase in permeate flux confirmed that salt barrier intrusion caused the increase in permeate conductivity in FIG. 13a. This observed salt intrusion suggested membrane degradation in the HPFD. However, the same membrane degradation characteristics were not observed in the full scale system. The permeate flux for HPFD MF+CF+UV decreased during start time, and stabilized at the end, while the permeate flux for MF pretreated water with GAC filtration also decreased slightly with time, then remained steady. Even though GAC was a very effective pretreatment method for removal of organics, it only removed hydrophobic fractions, so it did not remove the hydrophilic extracellular polymeric substance (EPS) produced by bacteria. The water quality data reported in Table 2 also indicated that there was no significant difference in the TOC content of the water after GAC treatment. This explained the flux decline shown for the GAC pretreated water. Both prototype trains' performance was steady until the plant was shut down to change the membrane configuration for both trains. Then, the trains were restarted. The changes in membrane configuration increased the flux, but it was steady until the end of run time. Overall, FIG. 13b shows that the HPFD was very sensitive to membrane degradation, which indicated the early warming function of this detector system.

FIG. 13c showed the differential pressure performances for prototype plant, HPFD, and LPFDs. The differential pressure for north train and south train was different due to different membrane configurations. However, the pattern for both trains was very similar. Slight increase in differential pressure was observed on LPFD. But there was no drastic increase observed for all pretreatment methods. No signs of membrane degradation or fouling were detected here based on the differential pressure.

(2) Physical Analysis

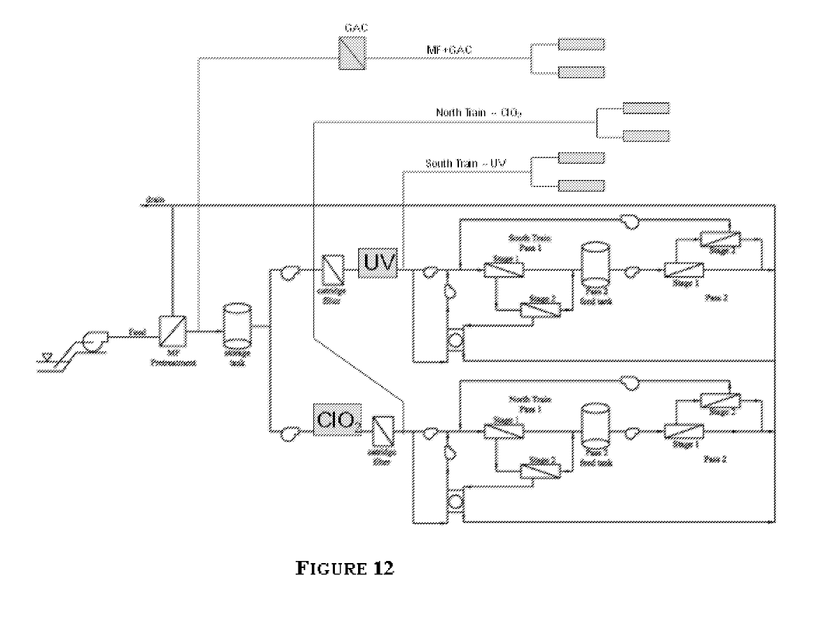

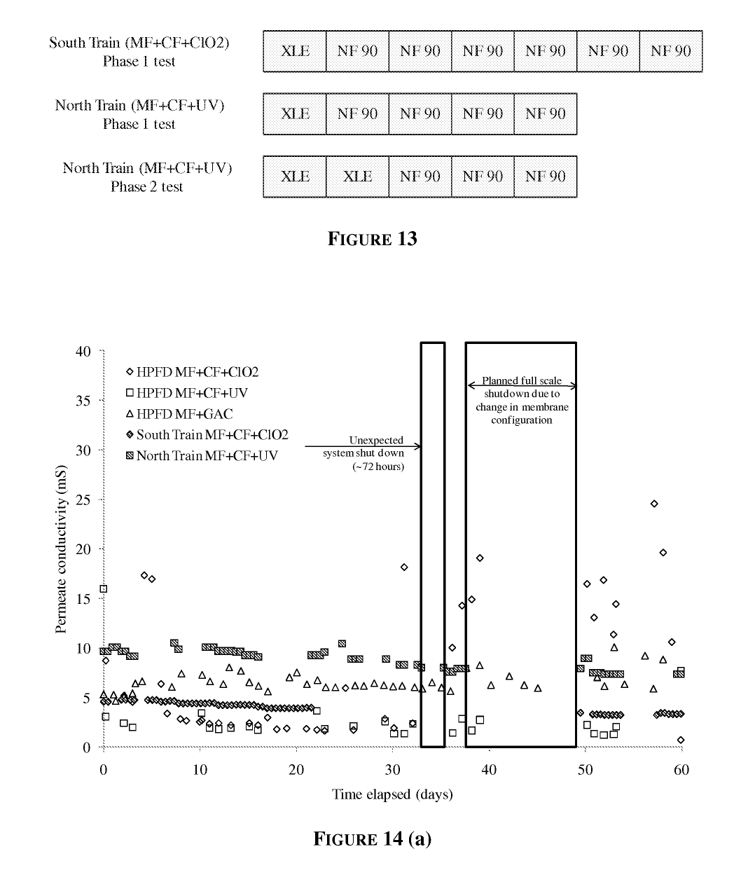

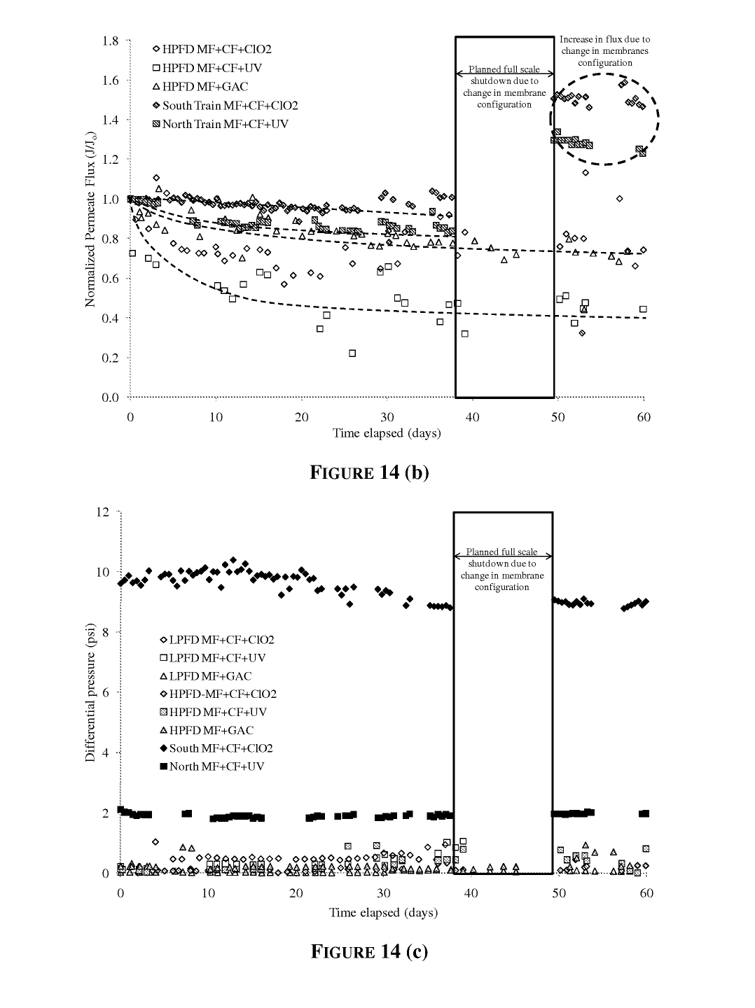

FIG. 14 shows the photographs for LPFD with (a) a clean membrane, (b) membrane with chlorine dioxide pretreated feed water, (c) membrane with UV radiation pretreated feed water, and (d) membrane with GAC pretreated feed water. Membrane shown in FIG. 14a was a clean new sheet of membrane. Membranes from FIGS. 14b, 14c, and 14d were extracted after the 60 days of run time.

Membranes from FIGS. 14a, 14b, and 14d looked the same after being extracted out of the LPFDs. The difference in tint observed was due to the different lighting when the photos were taken, so the brighter tint observed in Membrane from FIG. 14b was not because the chlorine dioxide bleached the membrane. The fouling was shown on the fouling detector (FIG. 14c). FIG. 14 showed that more fouling material was found on the membrane surface in which the feed water was affected by UV radiation compared to chlorine dioxide.

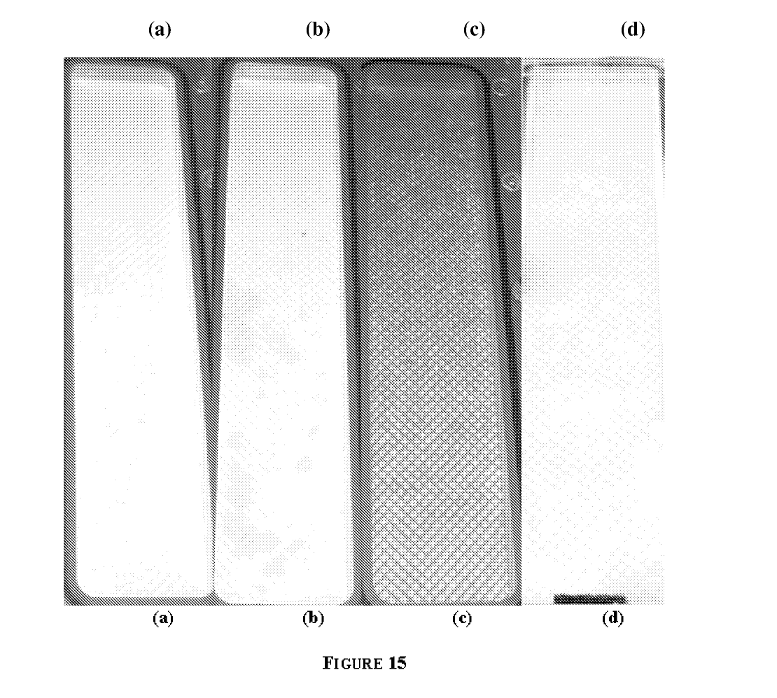

Solids analysis showed (FIG. 15) the membrane that was exposed to UV pretreatments contained significantly more solids than the membrane that was exposed to ClO₂. Moreover, the membrane that as exposed to ClO₂ had fewer solids than the membrane that was exposed to GAC.

ICP analysis indicated that all fouling material on the membrane surface had a similar combination of elements for the three pretreatments (FIG. 16). However, the feed water that was exposed to UV radiation contained chromium and iron. This confirmed the results of the solids analysis, which showed higher concentrations of inorganic solids (non-volatilized) than the organic solids.

(3) Biological Analysis

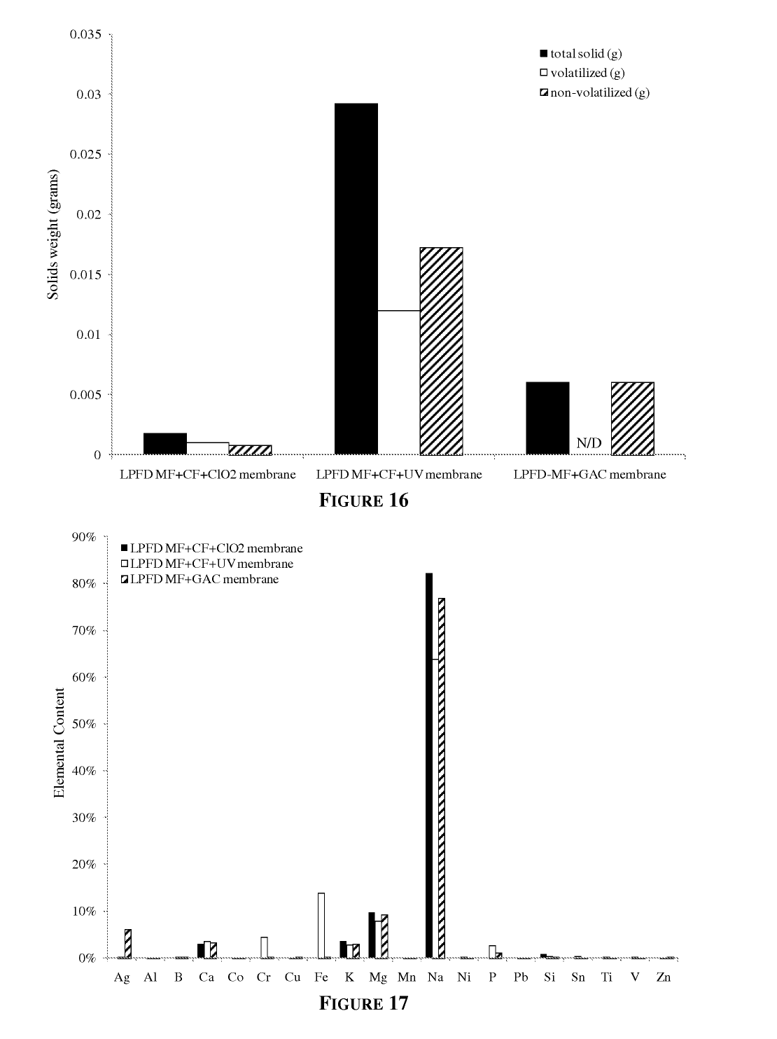

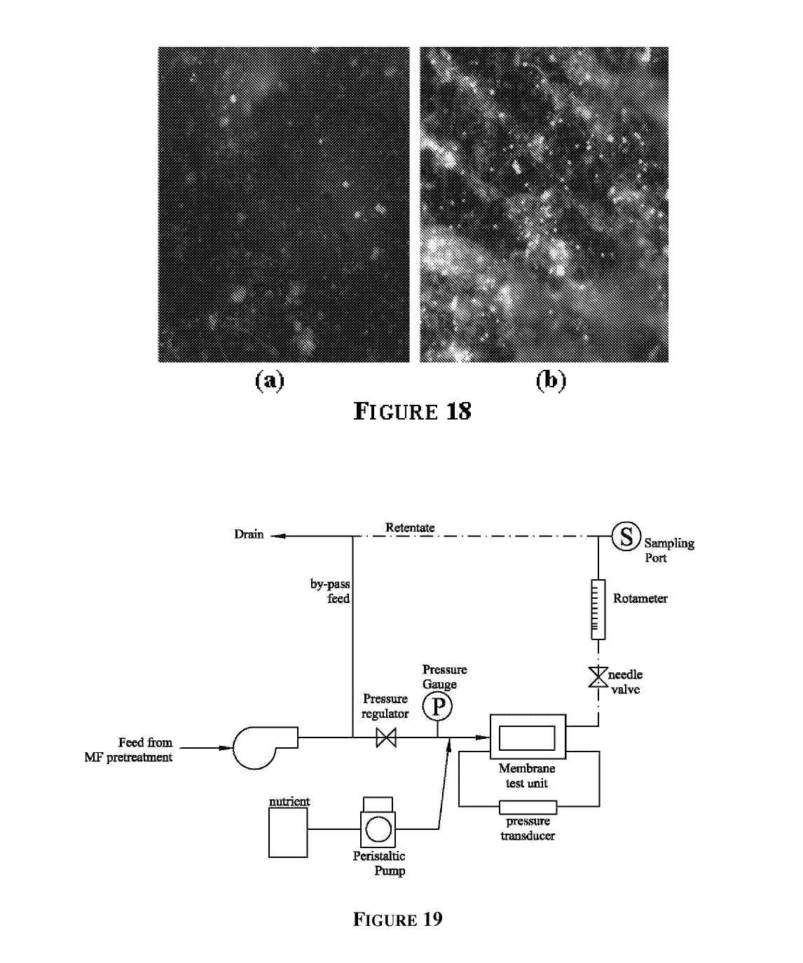

Cell density and biofilm thickness analysis revealed a significantly higher number of bacterial cells and greater biofilm thickness on membranes exposed to water treated with UV than those with GAC and ClO₂ (FIG. 17). The ClO₂ pretreatment significantly reduced the bacterial live cells although nearly equal amounts of dead bacteria were observed in LPFD. This observation confirmed the effective biocidal effect of ClO₂ in seawater pretreatment. Both LPFD and HPFD showed a similar trend of biofilm and bacterial accumulation under different pretreatments. The spiral wound membrane from the prototype plant had fewer bacterial cells although biofilm thickness was not significantly different from those on the fouling detectors (FIG. 17). Long filamentous bacteria were observed on the spiral wound membrane with UV pretreatment (FIG. 18). The filamentous bacteria were suspected to be the builders of the biofilm network that thickened the fouling layer. Overall, the biological data supported the physical analysis results and further confirmed that fouling detectors were a good indication of membrane condition and pretreatment efficiency at fouling reduction on the spiral wound membranes in the prototype desalination plant.

Clone libraries were constructed for membranes taken off from the prototype plant. The results showed that 86 bacterial clones were grouped into 20 OTUs. The diversity of the bacterial community was reduced in comparison with previous clone library from SWRO membrane (Zhang et al. 2010). There was no distinction between microorganisms found on membrane pretreated with UV or ClO₂. Only three clones from ClO₂ treated samples fell out off the main branch of alpha-proteobacteria and flavorbacteria. The sequencing results confirmed the previous observation that alpha-proteobacteria was commonly found on the seawater desalination membrane.

c. Summary

In comparing different types of pretreatment, additional UV radiation after MF and CF pretreatment did not have additional advantage in preventing biofouling. Membrane pretreated with UV had the worst biofouling. In comparing the UV and ClO₂ pretreatments with the GAC filtration, GAC appeared to work well in preserving permeate flux. However, bacterial cell density and biofilm thickness on the membrane with additional GAC treatment was not significantly different from those membranes without GAC. The water quality data also indicated that GAC treatment did not reduce the TOC concentration in the finished water.

In comparing the LPFD with the HPFD, LPFD had the advantage of having the viewing window in which it showed clearly the fouling on the membrane surface. Biological data indicated that membranes from LPFD and HPDF were comparable in terms of biofilm thickness and bacterial cell accumulation on membrane surfaces. Both were good representations of membrane condition on the prototype treatment trains for biofilm accumulation. While HPFD did not have a direct viewing window, as shown during the ClO₂ addition, membrane degradation was observed faster in the HPFD compared to the full-scale plant. Thus, HPFD served as an early warning system to detect membrane damage. ClO₂ worked well in preventing biofouling. This study showed that ClO₂ was effective in biofouling control in seawater desalination.

3. Nutrient Addition into Fouling Detectors to Simulate the Effect of Organic Carbon on Membrane Biofouling

Algae bloom is a concern for desalination plants due to the high concentration of biomass present in feed water. Algae bloom happens when a rapid increase in algal cell density occurs.

The elevated organic matters in feed water may overwhelm the pretreatment capacity in seawater desalination plants. The algal toxins pass through the pretreatment system present potential health risks, and dissolved organics also cause significant operational issues that result in increased membrane biofouling, increased chemical consumption, and in extreme cases, may cause plant shutdowns. Early detection of the negative impact of algae bloom is necessary to provide plant operators the tools necessary for making plant operational changes.

a. Materials and Methods

(1) High Pressure Fouling Detector (HPFD)

The high pressure fouling detector was composed of two pieces: (1) a top plate providing feed and concentrate ports, and the cross flow channel, and (2) a bottom plate containing the permeate channel and ports. Membrane coupon was placed between the two plates with the active side facing towards the top plate. Feed spacer was placed in between the active side of the membrane and the top plate, and permeate spacer was placed in between the back side of the membrane and the bottom plate. The two plates were bolted together with 18 stainless steel screws on the edges. All of the wetted part was made of 316 stainless steel material. Two layers of rubber o-ring gasket sealed the flow channel. The flow channel was designed to be 254 mm long and 50.8 mm wide with a feed channel height of 0.7 mm which matched the same thickness of the seawater NF membrane, the NF90. The HPFDs were operated at feed flow rate of 0.05 GPM and operating pressure of 550 psi.

(2) Low Pressure Fouling Detector (LPFD)

The low pressure fouling detector was composed of two pieces: (1) a top plate providing feed and concentrate ports, the cross flow channel, and a view window, and (2) a smooth bottom plate piece. Membrane coupon was placed between the two plates with the active side facing towards the view window. Feed spacer was placed in between the active side of the membrane and the top plate. The LPFD did not have permeation, so the backside of the membrane was placed directly against the bottom plate. The two plates were bolted together with 6 stainless steel screws on the edges. All of the wetted part was made of PVC material. A rubber o-ring gasket sealed the flow channel. The flow channel was designed to be 254 mm long and 50.8 mm wide with a feed channel height of 0.7 mm which matched the same thickness of the seawater NF membrane, the NF90. The LPFDs were operated at feed flow rate of 0.05 GPM and operating pressure of 6 psi.

(3) Feed Water Quality

The source water underwent several pretreatment processes before the desalination membranes and the fouling detectors. The pretreatments included trash racks at the channel intake that screened out coarse materials, 300 μm self-backwashing strainers prior to chlorination by sodium hypochlorite, and a 0.1 μm microfiltration (MF) system (Pall Microza, East Hills, N.Y.). Water exiting the MF filtrate tank was de-chlorinated using sodium bisulfate to achieve a chlorine residual of <0.1 mg/L. After dechlorination, the feed water passed through a cartridge filter (CF, Claris, PALL Corporation, East Hills, N.Y.) with polypropylene material 5 μm in pore size. These cartridge filters were changed out when the differential pressure across the filters reached 15 psi.

(4) Nutrient Mixture

(a) Complex Nutrient

The complex nutrient (N1) was a combination of peptone and yeast extract, which provided all amino acids that were required for bacterial growth. They represented non-selective media that encouraged the fast growing heterotrophic bacteria. To prepare the nutrient broth for seeding, a stock solution was mixed with DI water to contain 25 g/L peptone (Fisher Scientific, Hampton, N.H.) and 5 g/L yeast extract (Fisher Scientific, Hampton, N.H.). The stock solution was sterilized by autoclaving. The stock solution was continuously fed at 1:100 ratio with the feed water to a final concentration of 0.25 g/L peptone and 0.05 g/L of yeast extract. Since the feed water was at 0.05 gpm (189 mL/min) to match the prototype's Reynold's number, the stock solution was fed at 0.0005 gpm (1.9 mL/min) so as not to significantly alter the feed flow rate into the fouling detectors.

(b) Defined Nutrient

The second batch of nutrient (N2) was a combination of sodium acetate (Fisher Scientific, Pittsburgh, Pa.), sodium nitrate (Fisher Scientific, Pittsburgh, Pa.), and sodium phosphate (Fisher Scientific, Pittsburgh, Pa.), which were selected to represent defined carbon, nitrogen, and phosphate nutrient in feed water. The defined nutrient amendment experiments tested the effect of carbon, nitrogen, and phosphate ratio on the growth of microorganisms on RO membrane. The nutrient was mixed so that the C:N:P ratio of the nutrient was 100:20:10, an approximation of Redfield ratio for marine organic matter, and the total concentration was 1.0 mg/L. The nutrient solution was dosed into the feed line at 0.5 mL/min.

(5) Batch Growth Cultures Conducted in Laboratory

Optical density analysis was done on the two different types of nutrients. Three types of samples were prepared: (1) seawater with complex nutrient, (2) seawater with defined nutrient, and (2) seawater without nutrient addition (baseline). The nutrient solutions were sterilized by autoclave before being added into the seawater, and also, distributed into sterile 384-well polystyrene microplates (Greiner Bio One, Monroe N.C.). The optical density of samples in the microplates were then analyzed using a Victor 3V plate reader (PerkinElmer, Waltham, Mass.) using UV-VIS absorbance at 595 nm to establish bacterial cell growth rates with and without nutrients. In between plate readings, the well was stored in an incubator at 35° C. in the dark.

(6) Fouling Detector Set Up at the LBWD Prototype Plant

(a) LPFD with Nutrient Addition

Feed water from the prototype entered through a pressure regulator (Plast-O-Matic, Cedar Grove, N.J.) which adjusted the pressure at 6 psi. A peristaltic pump (Masterflex, Cole Palmers, Vernon Hills, Ill.) transferred the nutrient into the feed line after it passed through the pressure regulator (FIG. 19). Flexible tubing was used to connect the inlet and outlet of the detectors to the differential pressure transducer. The flow rate was controlled by a needle valve at the outlet of the detectors and monitored using a rotometer. The flow rate of the experiment was calculated so that it simulated the same Reynold's number of the prototype plant. The viewing windows of the detectors were covered with a piece of black plastic sheet to keep the membranes from getting UV exposure from sunlight.

(b) HPFD with Nutrient Addition

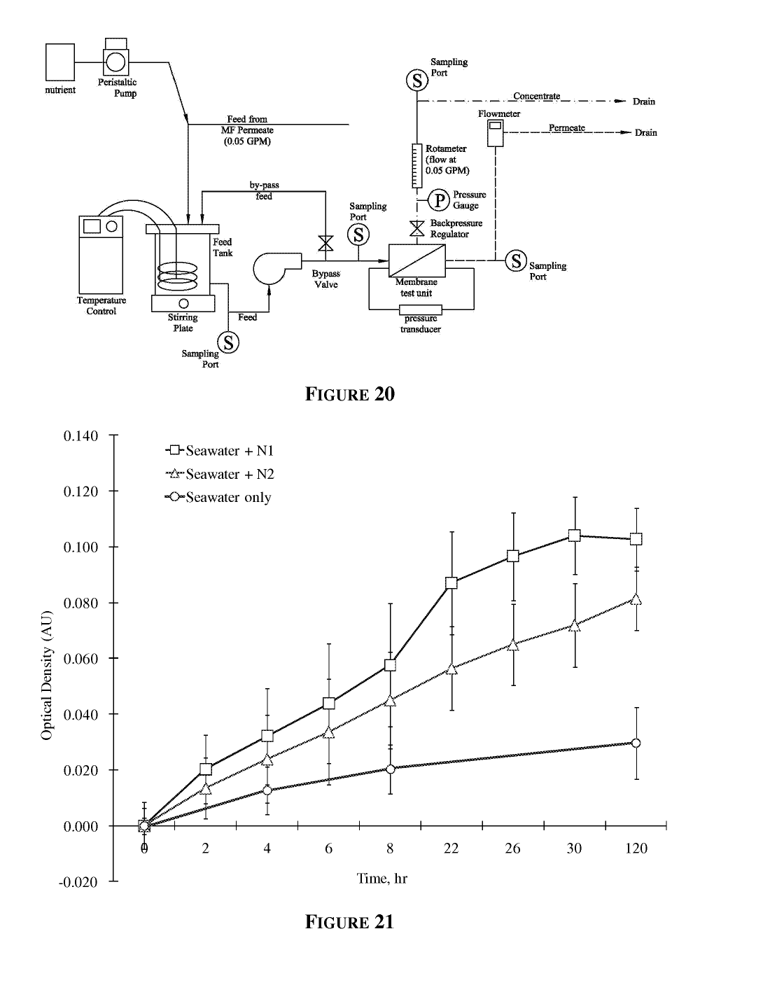

Feed water from MF pretreatment was passed through a cartridge filter (PALL Corporation, East Hills, N.Y.) at 0.05 gpm into the HPFD feed tank (FIG. 20). A peristaltic pump (Masterflex, Cole Palmers, Vernon Hills, Ill.) transferred nutrients into the feed tank feed line. The feed water was drawn by the high-pressure pump (Hydracell, Wanner Engineering, Minneapolis, N.Y.) and fed into the HPFD at a flow rate of 0.05 gpm and pressure of 550 psi to match the full scale plant's operating condition. The rest of the water was recycled back into the feed tank. A backpressure regulator (Swagelok, Camarillo, Calif.) and needle valve (Swagelok, Camarillo, Calif.) controlled flow rate and feed pressure for each feed line. Feed flow rate was measured by a hydraulic flow meter (King Instrument, Garden Grove, Calif.). The permeate flow was monitored by a digital flow meter (Tovatech, South Orange, N.J.). All experimental components under high pressure were made of stainless steel 316 materials. A chiller was used to control the temperature due to the elevated temperature of the bypassed feed water by the high-pressure pump.

(7) Sample Preparation and Analysis

Membrane samples were prepared for solids, ICP analysis, and biological analysis. Membrane samples were also imaged by scanning electron microscopy (SEM, Hitachi S-4700, Pleasanton, Calif.) to measure the thickness of fouling material contributed by the nutrients. Prior to the SEM analysis, dried samples were sputter-coated with a mixture of gold and palladium. Magnifications used were varied from 10,000× to 16,000×. Cross sections of the membrane were cut to show the fouling thickness on the membrane surface. Bacterial density and biofilm thickness were determined using a confocal microscope on membrane stained with SYTO 9 and propidium iodide nucleic acid stains following manufacturer's protocol (FilmTracer™ LIVE/DEAD Biofilm Viability Kit, Invitrogen, San Diego). Z sectioning method was used to determine the thickness of the biofilm. Bacterial density was evaluated by visually counting the number of cells attached to the membrane surface, and was determined by the average count number of 3 images for each sample.

b. Results and Discussions

(1) Bacterial Growth in Batch Cultures

The optical density analysis showed that samples dosed with complex nutrient produced slightly faster bacterial growth than samples dosed with defined nutrient (FIG. 21), while both nutrients increased bacterial growth rates far above the baseline. This data suggested that the concentration of the complex nutrient was higher than the defined nutrient. This was expected because complex nutrient was non-selective and supported the fast growth of heterotrophic bacteria.

(2) Fouling Detector Performance

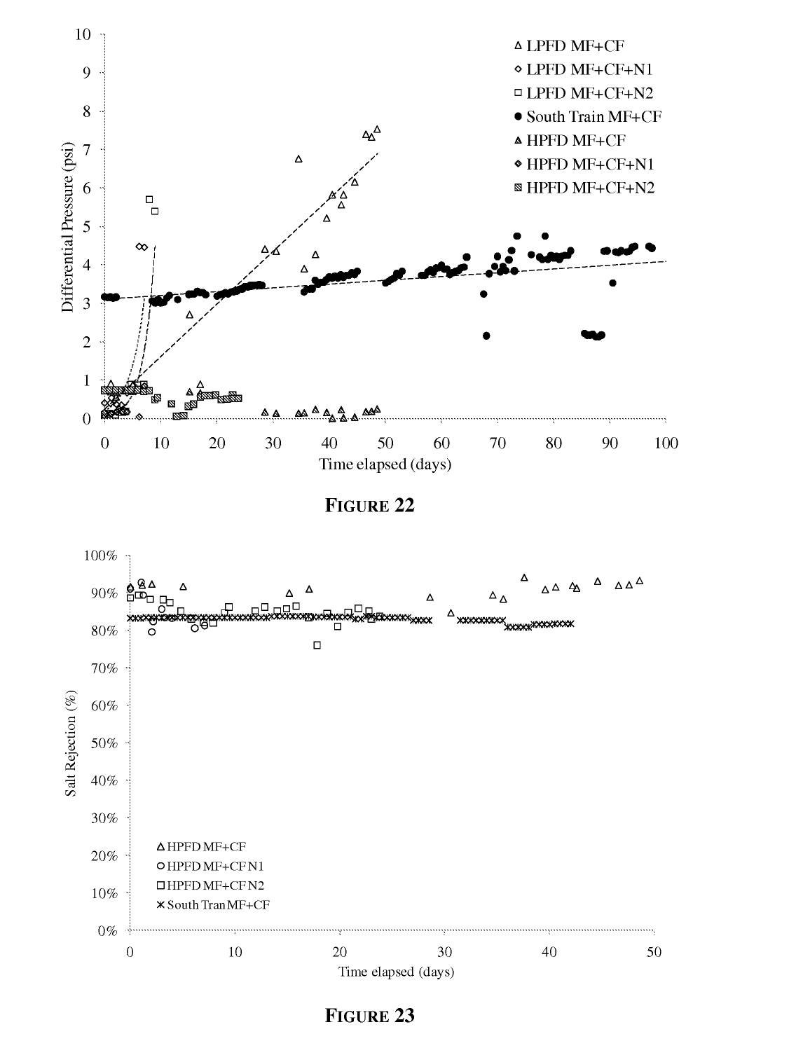

FIG. 22 shows differential pressure versus time for the complex (N1) and dissolved (N2). The differential pressure for the low-pressure detectors exposed to the two nutrients increased faster than the low-pressure detectors without nutrient addition, which suggested biogrowth was stimulated by nutrient addition. The fouling detectors with nutrients added reached a differential pressure of 6 psi in 7-10 days, whereas the fouling detectors without nutrient addition took 40 days to reach differential pressure of 6 psi. The complex nutrient stimulated fouling slightly faster than the defined nutrient, thus, replicating the batch culture results from the laboratory (FIG. 21). Full-scale data in FIG. 22 suggested about 2 psi increase in differential pressure over the same time period (no artificial nutrients were added to the plant feed). The 6 psi and 2 psi increases in the fouling detector and full-scale plant differential pressures caused 1.1 and 0.36% loss of trans-membrane pressure, respectively, because the applied pressure was 550 psi. This suggested that any flux decline observed in the plant was >99% due to foulant accumulation on the membrane.

The high-pressure detectors did not show any significant change in differential pressure (FIG. 22). Therefore, the low-pressure detectors might have responded to a type of fouling that did not occur as fast (or at all) when there was flux through the membrane (i.e., in both the HPFDs and the full-scale plant). The HPFD MF+CF+N2 experiment was allowed to run longer than the fouled LPFD to evaluate if the differential pressure would increase, but after 25 days no increase was observed.

In the high-pressure detectors, salt rejection and permeate flux data was available continuously over the course of the nutrient dosing experiment. The complex nutrient, produced 80% flux decline and 10% decrease in salt rejection over 40-50 days (FIG. 23).

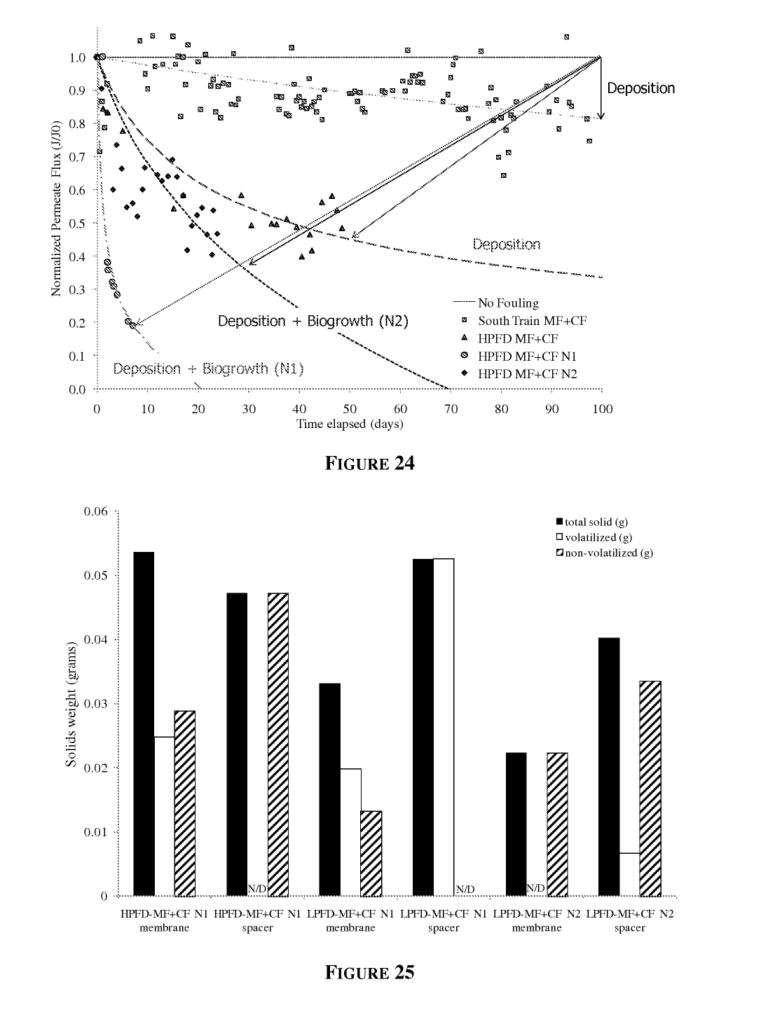

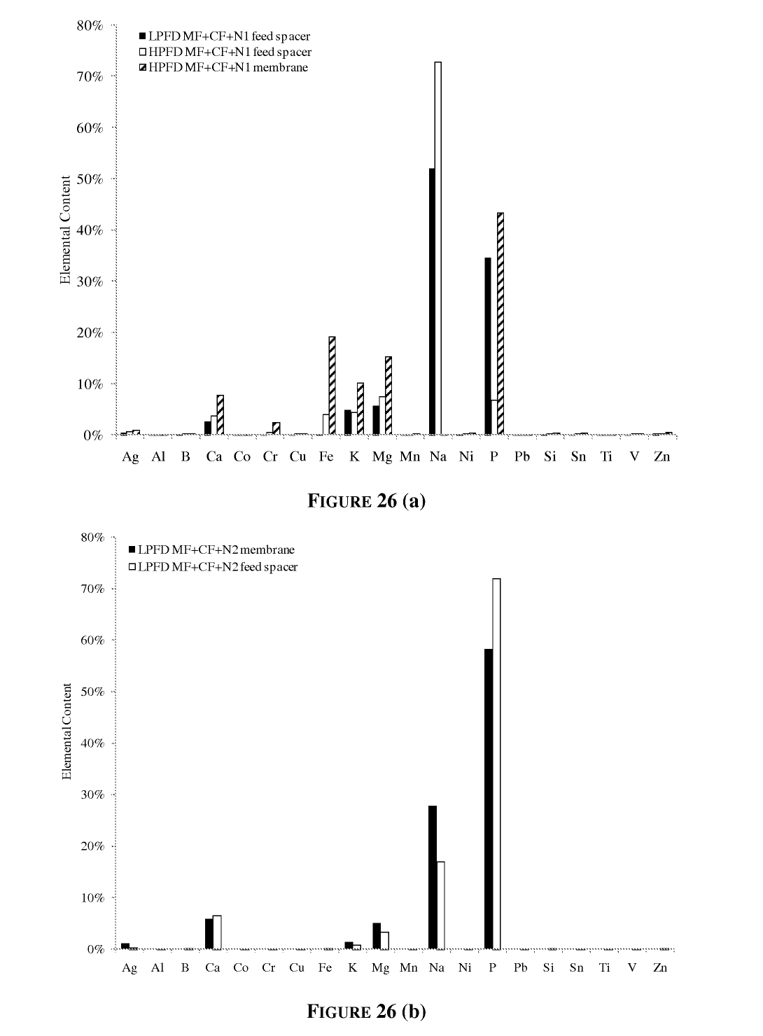

The south train of the full-scale plant experienced very little flux decline, while the high-pressure detectors with and without nutrients exhibited significant flux decline over the same period (FIG. 24). The HPFD operating without artificial nutrient addition experienced a much faster rate of flux decline than the full-scale plant because the actual flux through the HPFD membrane was 50% higher than the average flux of the full-scale plant. As fouling progressed, more water permeated elements further down the system and the high permeability allowed the system average flux (and overall recovery) to appear constant. However, in the HPFD there was only a small amount of membrane area operating at a relatively high flux. In fact, the HPFD was designed to simulate the first 10-12 inches of the full-scale system where flux and fouling are expected to be most severe and the HPFD operated as designed.

Flux decline was much steeper in the HPFD dosed with complex nutrient than in the HPFD dosed with defined nutrient. Based on the full scale data, 20% flux decline was observed within 3 months of operation (without artificial nutrient addition). Of this 20% flux decline, 0.4% was due to the increase in differential pressure (FIG. 22a); hence, the bulk of flux decline observed here was caused by foulant accumulation directly on the membrane surface rather than clogging of the feed spacers.

(3) Physical Analyses

Solids accumulated on the membrane and the feed spacer during complex and defined nutrient addition experiments revealed additional insights about mechanisms of fouling (FIG. 25). More total solids were found on the spacer than the membrane surface for both low-pressure detectors. However, more solids were observed on the membrane surface in the high-pressure detectors. In an actual spiral wound element, two membrane surfaces shared a spacer and a spacer channel, thus was a greater distribution of foulant mass on the membrane surface rather than on the spacers. Overall, the HPFDs mimicked the full-scale plant behavior more completely and more accurately than the LPFDs.

The ICP analysis confirmed that the chemical composition of solids found on the membrane surfaces was consistent for both complex and defined nutrient. Both nutrients gave rise to fouling layers of similar chemical compositions despite differences in the physical-chemical properties of the nutrients themselves. Higher concentrations of iron were found in HPFDs than in LPFDs.

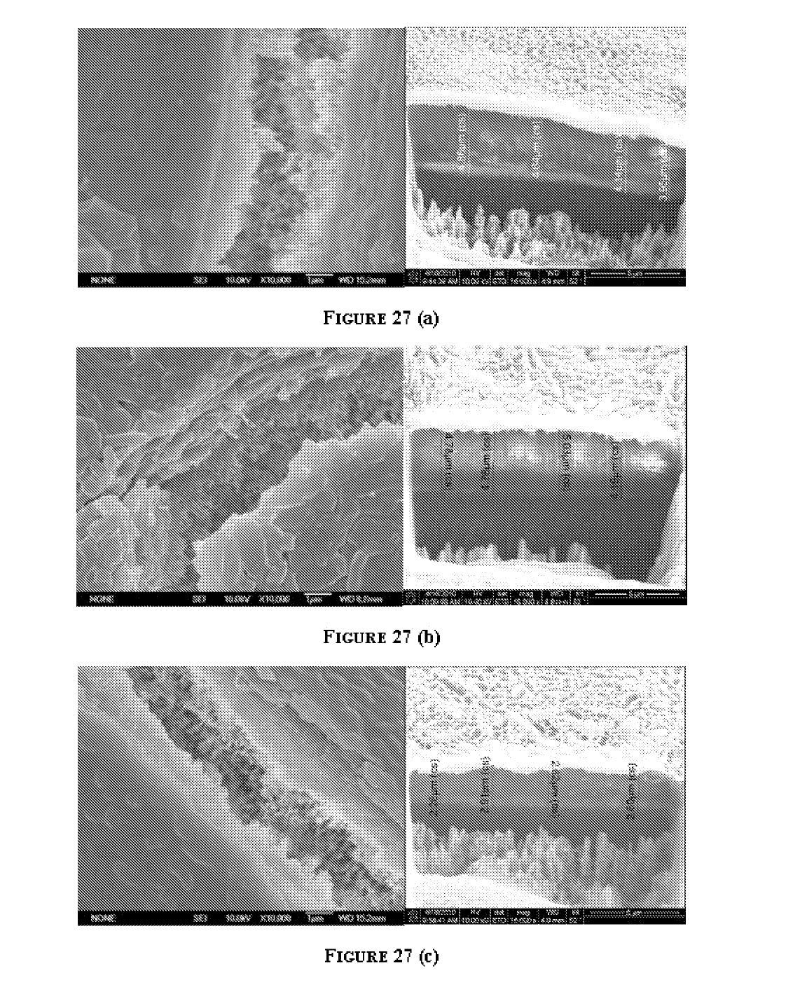

Electron microscopy was performed on membrane coupons extracted from the fouling detectors (FIG. 27). A thick dehydrated biofouling layer, i.e. ˜5 μm, was observed in the membrane coupon extracted from the low-pressure detector that had been exposed to complex nutrient (LPFD MF+CF+N1). A dehydrated biofouling layer with similar thickness was observed from high-pressure detector (HPFD MF+CF+N1) exposed to the same nutrient composition (complex). However, the fouling layer on the membrane surface from the low-pres sure detector exhibited a more uniform shape than the fouling layer on membrane surface from the high-pressure detector. The fouling layer on the surface of the membrane from the high-pressure detector seemed to be morphologically diverse. For membrane coupon that had been exposed to defined nutrient (LPFD MF+CF+N2), a thinner dehydrated biofouling layer, ˜2.5 μm, was formed. Moreover, no uniform cell shape was observed, suggesting that the type of nutrient impacted the amount of biomass that accumulated on the membrane.

(4) Biological Analyses

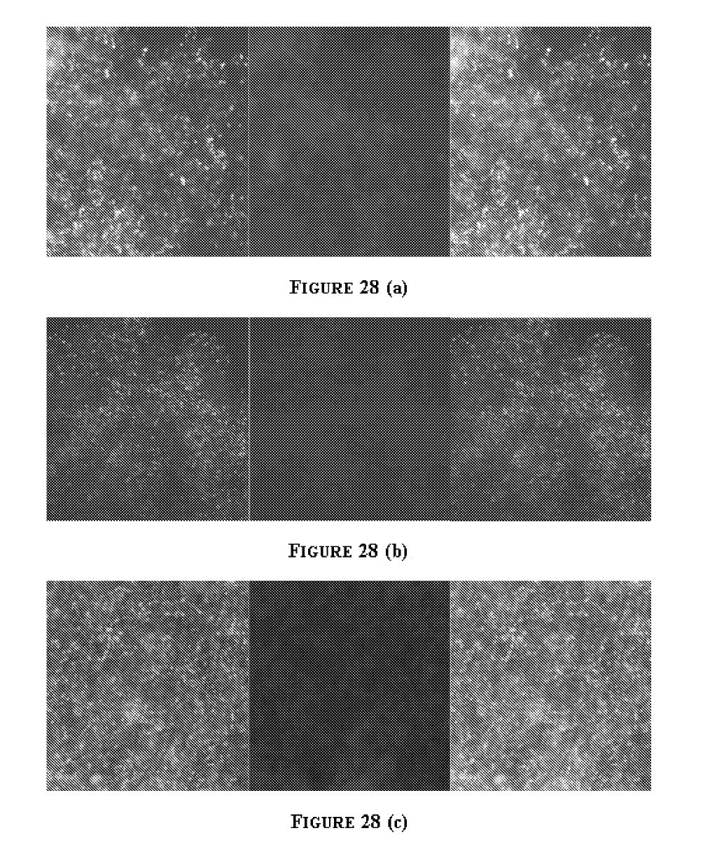

Cell density and biofilm thickness were significantly higher for membrane exposed to N1 (FIG. 28). Fouling layer on membrane surface exposed to N2 was less dramatic in comparison with N1 addition, but nevertheless, the data showed promoted growth of bacteria on the membrane surface. These results indicated both complex and simple organic carbon stimulated bacteria growth in MF pretreated seawater. Biofilm thickness was significantly higher than the fouling layer reported on the dehydrated membrane by SEM. This was because biofilm was composed of 90% water. Dehydration significantly altered the fouling thickness, but SEM sample preparation, which involved dehydrating samples followed by sputter coating, also modified the visual appearance of biofilms. Confocal microscopy was a cheaper and effective method for evaluation of biofilm thickness and cell density on membrane surfaces.

In comparing bacterial cells and biofilm thickness on HPFD and LPFD treated with N2, it showed that HPFD had less cells and biofilm than LPFD. The high pressure environment prevented the establishment of biofilm on HPFD membrane. This result supported the observation that differential pressure change in LPFD was more pronounced. However, the full scale membrane was more similar to the HPFD membrane under the influence of organic carbon addition.

c. Summary

The impacts of complex and defined nutrient on flux, rejection, and differential pressure were investigated using high-pressure and low-pressure fouling detectors; the functional difference being that water permeated through the RO membranes in high-pressure detectors. In low-pressure detectors, both nutrients produced rapid increase in differential pressure within 24 to 48 hours. In high-pressure detectors, the nutrients produced 60-80% flux decline within 10-20 days, but there was no noticeable change in salt rejection or differential pressure. In low-pressure detectors, more foulant mass accumulated in the feed spacers than on the membrane surfaces; however, in high-pressure detectors, more fouling mass accumulated on the membrane surface than on the feed spacers. Electron and confocal microscopy analyses confirmed that more fouling mass was found on membrane surfaces exposed to complex nutrient than the defined nutrient, suggesting complex nutrient may have fouled the membranes directly by complex deposition and cake formation as well as indirectly by stimulating biogrowth and biofilm formation.

4. Membrane-Based Production of Salinity-Gradient Power

In various further aspects, the described methods and apparatuses can be used in connection with system for membrane-based production of salinity-gradient power. That is, for example, the described methods and apparatuses can be used to detecting membrane fouling in membrane-based salinity-gradient power production systems.

Thus, in one aspect, the invention relates to a method for detecting membrane fouling in a salinity gradient power system, the method comprising providing a high pressure monitoring cell in parallel with the system, the cell comprising a membrane; passing a sample side-stream from a brine stream of the system through the membrane cell at an ambient brine stream pressure, thereby generating a differential pressure along the membrane length, generating a transmembrane pressure drop through the membrane, and generating a membrane draw flux through the membrane; and measuring one or more of: differential pressure, transmembrane pressure drop, and draw flux.

In one aspect, an increase in differential pressure indicates fouling of the salinity gradient power system membrane. In one aspect, an increase in transmembrane pressure drop indicates fouling of the salinity gradient power system membrane. In one aspect, a decrease in draw flux indicates fouling of the salinity gradient power system membrane.

a. Pressure-Retarded Osmosis

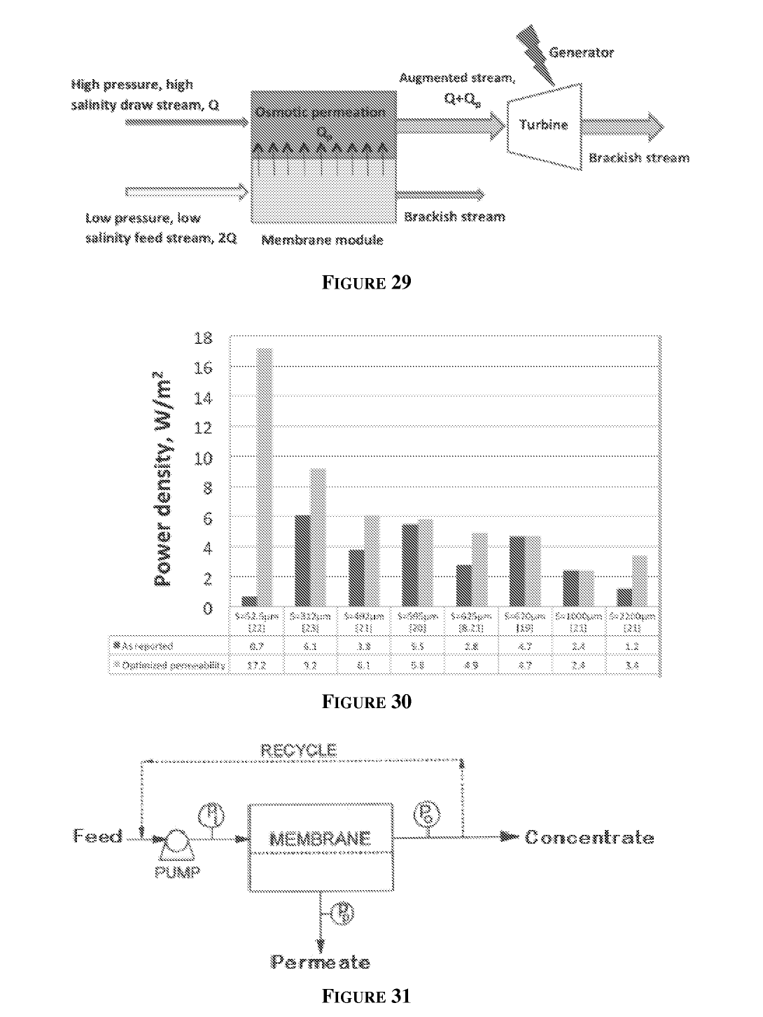

The operating principle of PRO was as follows; driven by the chemical potential difference, water diffuses through a semi-permeable membrane from a low salinity stream (high chemical potential) into a high-salinity (low chemical potential), pressurized draw stream; thereby, increasing its pressure and flow rate. The augmented flow of the pressurized stream then passed through a hydroelectric turbine which extracted the power (FIG. 29). The driving force for osmosis was the water chemical potential gradient across the membrane which, in an isothermal system, can be expressed as the difference in osmotic pressure of the concentrated and dilute solutions.

The power in the PRO process was completely analogous to hydroelectric power and was the product of the augmented flow rate and pressure drop through a hydro-turbine. For example, if the concentrated stream was pressurized to ˜10 bar (˜1 MPa), then for a permeation flow rate of 1 m^{3/s} the power output would be ˜1 MW. Furthermore, the maximum power density occurred when the applied pressure was equal to half the osmotic pressure. A prerequisite for an efficient PRO process was the membrane permeability; a low permeability membrane would rendered the conversion of even a high salinity gradient inefficient.

b. Pressure Retarded Osmosis Membranes

The membrane with the best structure factor was a cellulose-acetate phase-inversion membrane with a thickness of ˜35 μm and a structure factor of ˜50 μm, followed by ˜390 μm reported for a thin-film composite polyamide/polysulphone membrane, which along with its relatively high permeability (˜5.3.10⁻¹² m/s·Pa) had the highest projected performance at 5.9 W/m² and 18.7 W/m² for seawater and RO brine, respectively, serving as the concentrated solution. The highest permeability was ˜7.10-¹² m/s·Pa, also for a composite membrane, which was about double that of the average commercial seawater RO membrane.

PRO simulations illustrated that, given a set of inherent ‘inefficiencies’, namely the salt permeability, structure factor and external mass transfer coefficient, there existed an optimal membrane permeability, which maximized power. In light of this observation, the compilation of membrane characteristics were used to compare performance based on reported values with that achievable with an ‘optimized’ water permeability coefficient. The results are presented in FIG. 30. All the membranes considered, save one, were not at their optimal performance in terms of matching the permeability to all other membrane traits. Moreover, this analysis showed that even membranes with high structure factors (>1 mm) were limited by their permeability, not the structure factor.

### E. REFERENCES

[1] A. Subramani, E. M. V. Hoek, Direct observation of initial microbial deposition onto reverse osmosis and nanofiltration membranes, J. Membr. Sci., 319 (2008) 111-125.
[2] A. Subramani, S. Kim, E. M. V. Hoek, Pressure, flow, and concentration profiles in open and spacer-filled membrane channels, Journal of Membrane Science, 277 (2006) 7-17.
[3] A. Subramani, X. Huang, E. M. V. Hoek, Direct observation of bacterial deposition onto clean and organic-fouled polyamide membranes, Journal of Colloid and Interface Science, 336 (2009) 13-20.
[4] C. L. Gallegos, Phytoplankton photosynthesis, productivity, and species composition in a eutrophic estuary—comparison of bloom and non-bloom assemblages, Marine Ecology-Progress Series, 81 (1992) 257-267.
[5] C. L. Gallegos, T. Platt, W. G. Harrison, B. Irwin, Photosynthetic parameters of arctic marine-phytoplankton—vertical variations and time scales of adaptation, Limnology And Oceanography, 28 (1983) 698-708.
[6] D. Tanuwidjaja, Usage of High Pressure and Low Pressure Fouling Detectors to Simulate Full Scale Seawater Desalination Plant Performance, Journal of Membrane Science, (2010) submitted.
[7] D. Tanuwidjaja, X. Jin, X. Huang, C. Marambio-Jones, M. Zhang, S. Jiang, R. C. Cheng, E. M. V. Hoek, Analyses of Membrane Fouling and Cleaning in One-pass RO and Two-Pass NF Seawater Desalination Systems, Journal of Membrane Science, (2010) submitted.
[8] D. A. Caron, M.-É. Garneau, E. Seubert, M. D. A. Howard, L. Darjany, A. Schnetzer, I. Cetinic, G. Filteau, P. Lauri, B. Jones, S. Trussell, Harmful algae and their potential impacts on desalination operations off southern California, Water Research, 44 385-416.
[9] D. A. Stahl, R. Key, B. Flesher, J. Smit, The phylogeny of marine and freshwater caulobacters reflects their habitat, J. Bacteriol., 174 (1992) 2193-2198.
[10] E. M. V. Hoek, J. Allred, T. Knoell, B.-H. Jeong, Modeling the effects of fouling on full-scale reverse osmosis processes, Journal of Membrane Science, 314 (2008) 33-49.
[11] G. Fiala, K. O. Stetter, Pyrococcus furiosus sp. nov. represents a novel genus of marine heterotrophic archaebacteria growing optimally at 100° C., Archives of Microbiology, 145 (1986) 56-61.
[12] G. Guillen, E. M. V. Hoek, Modeling the impacts of feed spacer geometry on reverse osmosis and nanofiltration processes, Chemical Engineering Journal, 149 (2009) 221-231.
[13] G. Schock, A. Miguel, Mass transfer and pressure loss in spiral wound modules, Desalination, 64 (1987) 339-352.
[14] G. H. Tilstone, F. G. Figueiras, E. G. Fermin, B. Arbones, Significance of nanophytoplankton photosynthesis and primary production in a coastal upwelling system (Ria de Vigo, NW Spain), Marine Ecology-Progress Series, 183 (1999) 13-27.
[15] J. S. Vrouwenveder, J. A. M. van Paassen, J. M. C. van Agtmaal, M. C. M. van Loosdrecht, J. C. Kruithof, A critical flux to avoid biofouling of spiral wound nanofiltration and reverse osmosis membranes: Fact or fiction?, J. Membr. Sci., 326 (2009) 36-44.
[16] J. S. Vrouwenvelder, C. Hinrichs, W. G. J. Van der Meer, M. C. M. Van Loosdrecht, J. C. Kruithof, Pressure drop increase by biofilm accumulation in spiral wound RO and NF membrane systems: role of substrate concentration, flow velocity, substrate load and flow direction, Biofouling, 25 (2009) 543-555.
[17] J. S. Vrouwenvelder, D. A. Graf von der Schulenburg, J. C. Kruithof, M. L. Johns, M. C. M. van Loosdrecht, Biofouling of spiral-wound nanofiltration and reverse osmosis membranes: A feed spacer problem, Water Research, 43 (2009) 583-594.
[18] J. S. Vrouwenvelder, J. A. M. van Paassen, J. C. Kruithof, M. C. M. van Loosdrecht, Sensitive pressure drop measurements of individual lead membrane elements for accurate early biofouling detection, J. Membr. Sci., 338 (2009) 92-99.
[19] J. S. Vrouwenvelder, J. A. M. van Paassen, L. P. Wessels, A. F. van Dama, S. M. Bakker, The membrane fouling simulator: A practical tool for fouling prediction and control, J. Membr. Sci., 281 (2006) 316-324.
[20] J. S. Vrouwenvelder, J. A. M. v. Paassen, L. P. Wessels, A. F. v. Dama, S. M. Bakker, The membrane fouling simulator: a practical tool for fouling prediction and control, Journal of Membrane Science, 281 (2006) 316-324.
[21] J. S. Vrouwenvelder, S. A. Manolarakis, J. P. van der Hoek, J. A. M. van Paassen, W. G. J. van der Meer, J. M. C. van Agtmaal, H. D. M. Prummel, J. C. Kruithof, M. C. M. van Loosdrecht, Quantitative biofouling diagnosis in full scale nanofiltration and reverse osmosis installations, Water Res., 42 (2008) 4856-4868.
[22] K. L. Chen, L. F. Song, S. L. Ong, W. J. Ng, The development of membrane fouling in full-scale RO processes, Journal of Membrane Science, 232 (2004) 63-72.
[23] L. S. Clesceri, A. E. Greenberg, A. D. Eaton, M. A. H. Franson, American Public Health Association., American Water Works Association., Water Environment Federation., Standard Methods for the Examination of Water and Wastewater, 20th ed., American Public Health Association, Washington, D.C., 1998.
[24] L. W. Harding, B. W. Meeson, T. R. Fisher, Phytoplankton production in 2 east-coast estuaries—photosynthesis light functions and patterns of carbon assimilation in chesapeake and delaware bays, Estuarine Coastal And Shelf Science, 23 (1986) 773-806.
[25] M. Petry, M. A. Sanz, C. Langlais, V. Bonnelye, J.-P. Durand, D. Guevara, W. M. Nardes, C. H. Saemi, The El Coloso (Chile) reverse osmosis plant, Desalination, 203 (2007) 141-152.
[26] M. Uchymiak, A. Rahardianto, E. Lyster, J. Glater, Y. Cohen, A novel RO ex situ scale observation detector (EXSOD) for mineral scale characterization and early detection, J. Membr. Sci., 291 (2007) 86-95.
[27] M. Uchymiak, A. R. Bartman, N. Daltrophe, M. Weissman, J. Gilron, P. D. Christofides, W. J. Kaiser, Y. Cohen, Brackish water reverse osmosis (BWRO) operation in feed flow reversal mode using an ex situ scale observation detector (EXSOD), J. Membr. Sci., 341 (2009) 60-66.
[28] M. N. Kyewalyanga, T. Platt, S. Sathyendranath, V. A. Lutz, V. Stuart, Seasonal variations in physiological parameters of phytoplankton across the north Atlantic, Journal Of Plankton Research, 20 (1998) 17-42.
[29] M.-O. Lee, J.-K. Kim, Characteristics of algal blooms in the southern coastal waters of Korea, Marine Environmental Research, 65 (2008) 128-147.
[30] M. R. Lewis, E. P. W. Horne, J. J. Cullen, N. S. Oakey, T. Platt, Turbulent motions may control phytoplankton photosynthesis in the upper ocean, Nature, 311 (1984) 49-50.
[31] S. Kang, E. M. V. Hoek, H. Choi, H. Shin, Effect of membrane surface properties during the fast evaluation of cell attachment, Sep. Sci. Technol., 41 (2006) 1475-1487.
[32] S. Kim, S. Lee, E. Lee, S. Sarper, C.-H. Kim, J. Cho, Enhanced or reduced concentration polarization by membrane fouling in seawater reverse osmosis (SWRO) processes, Desalination, 247 (2009) 162-168.
[33] S. Wang, G. Guillen, E. M. V. Hoek, Direct observation of microbial adhesion to membranes, Environ. Sci. Technol., 39 (2005) 6461-6469.
[34] S. T. Kang, A. Subramani, E. M. V. Hoek, M. A. Deshusses, M. R. Matsumoto, Direct observation of biofouling in cross-flow microfiltration: mechanisms of deposition and release, J. Membr. Sci., 244 (2004) 151-165.
[35] T. Platt, A. D. Jassby, Relationship between photosynthesis and light for natural assemblages of coastal marine-phytoplankton, Journal Of Phycology, 12 (1976) 421-430.
[36] T. Platt, S. Sathyendranath, O. Ulloa, W. G. Harrison, N. Hoepffner, J. Goes, Nutrient control of phytoplankton photosynthesis in the western north-atlantic, Nature, 356 (1992) 229-231.
[37] T. C. Malone, P. J. Neale, Parameters of light-dependent photosynthesis for phytoplankton size fractions in temperate estuarine and coastal environments, Marine Biology, 61 (1981) 289-297.
[38] V. L. Trainer, N. G. Adams, B. D. Bill, C. M. Stehr, J. C. Wekell, P. Moeller, M. Busman, D. Woodruff, Domoic Acid Production Near California Coastal Upwelling Zones, June 1998, Limnology and Oceanography, 45 (2000) 1818-1833.
[39] X. Huang, G. R. Guillen, E. M. V. Hoek, A New High-Pressure Optical Fouling Detector for Direct Observation of Seawater RO Membrane Fouling and Cleaning, Journal of Membrane Science, submitted (2010).
[40] Y. Le Gouellec De Schwarz, A. R. Foundation, D. Long Beach. Water, A novel approach to seawater desalination using dual-staged nanofiltration, Awwa Research Foundation: American Water Works Association; IWA Publishing, Denver, Colo.; [si], 2006.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for detecting membrane fouling in a membrane-based water processing system, the method comprising:
providing a high pressure monitoring cell in parallel with the water processing system, the cell comprising a membrane;
passing a sample side-stream from a feed stream or a brine stream of the water processing system through the membrane cell at an ambient feed or brine stream pressure, thereby generating a differential pressure along the membrane length, generating a transmembrane pressure drop through the membrane, and generating a membrane flux through the membrane; and
measuring one or more of:
differential pressure, wherein an increase indicates fouling of the water processing system membrane,
transmembrane pressure drop, wherein an increase indicates fouling of the water processing system membrane, and
flux, wherein a decrease indicates fouling of the water processing system membrane.

2. The system of claim 1, wherein:
the membrane-based water processing system is a desalination system,
the sample side-stream is from a feed stream of the system, and
flux is permeate flux.

3. The system of claim 1, wherein:
the membrane-based water processing system is a salinity gradient power system,
the sample side-stream is from a brine stream of the system, and
flux is draw flux.

4. The method of claim 1, wherein two or more of differential pressure, transmembrane pressure drop, and flux are measured.

5. The method of claim 1, wherein the method further comprises measuring permeate conductivity.

6. The method of claim 1, wherein the sample stream feed pressure is at least about 300 psi.

7. The method of claim 1, wherein the sample stream feed pressure is about 550 psi.

8. The method of claim 1, wherein the water processing system comprises a reverse osmosis membrane.

9. The method of claim 1, wherein the water processing system comprises an forward osmosis membrane.

10. The method of claim 1, wherein the water processing system comprises a nanofiltration membrane.

11. The method of claim 1, wherein the water processing system comprises a pressure retarded osmosis membrane.

12. The method of claim 1, wherein one or more of differential pressure, transmembrane pressure drop, and flux is measured prior to applying a cleaning solution to the water processing system membrane.

13. The method of claim 1, wherein one or more of differential pressure, transmembrane pressure drop, and flux is measured after pretreating the water processing system membrane.

14. The method of claim 1, wherein the high pressure monitoring cell comprises:
a membrane having a surface on an active feed side; and
a flow head configured and arranged to direct a sample feed stream or brine stream from the water processing system through the surface of the membrane and to thereby generate a concentrate stream on the active side of the membrane and a draw stream or permeate stream opposite the active feed side of the membrane; and
coupled to the cell, a means for measuring one or more of differential pressure, transmembrane pressure drop, and flux.

15. A high pressure monitoring cell for use in detecting membrane fouling in a membrane-based water processing system, the cell comprising:
a membrane having a surface on an active feed side; and
a flow head configured and arranged to direct a sample feed stream or brine stream from the water processing system through the surface of the membrane and to thereby generate a concentrate stream on the active side of the membrane and a draw stream or permeate stream opposite the active feed side of the membrane; and
coupled to the cell, a means for measuring one or more of differential pressure, transmembrane pressure drop, and flux.

16. The high pressure monitoring cell of claim 15, wherein the flow head comprises:
a first substrate having an input port, an output port, and a cross flow channel configured to direct the feed stream through the active side of the membrane at about at least 400 psi, the substrate located adjacent the active side of the membrane; and
wherein the cell further comprises:
a second substrate having a permeate channel and permeate port, the substrate located opposite the active feed side of the membrane, and the permeate channel aligned with the cross flow channel;
a feed-side detector coupled to the first substrate so as to interact with the feed stream; and
a permeate-side detector coupled to the second substrate so as to interact with the permeate stream.

17. The high pressure monitoring cell of claim 16, further comprising
a feed spacer located between the first substrate and the active side of the membrane; and
a permeate spacer located between a surface opposite the active side of the membrane and the second substrate.

18. The high pressure monitoring cell of claim 17, wherein feed channel height of the cross flow channel is adjusted according to the thickness of the spacer.

19. The high pressure monitoring cell of claim 18, wherein the monitoring cell is in parallel with a desalination system.

20. The high pressure monitoring cell of claim 19, wherein the monitoring cell is located in front of the adjacent membrane.
